(19) United States
(12) Patent Application Publication
(10) Pub. No.: US 2017/0017475 A1
(43) Pub. Date: Jan. 19, 2017

(54) INFORMATION PROCESSING APPARATUS AND COMPILE METHOD

(71) Applicant: FUJITSU LIMITED, Kawasaki-shi (JP)

(72) Inventor: Tsuguchika TABARU, Machida (JP)

(73) Assignee: FUJITSU LIMITED, Kawasaki-shi (JP)

(21) Appl. No.: 15/202,922

(22) Filed: Jul. 6, 2016

(30) Foreign Application Priority Data
Jul. 14, 2015 (JP) 2015-140891

(51) Int. Cl. G06F 9/45

(52) U.S. Cl. CPC G06F 8/4441

(57) ABSTRACT

An information processing apparatus includes a memory; and one or more processors coupled to the memory and configured to specify a loop portion in which computation regarding a first expression, which performs a contraction operation with respect to a first variable, is repeated, in a first program code of software, generate a first code in which computation regarding a second expression, which performs a contraction operation on a sub-expression of the first expression with respect to a second variable, is repeated and a second code in which computation regarding a third expression, where the sub-expression of the first expression is replaced with the second variable, is repeated, and output a second program code in which the loop portion of the first program code is transformed into the first code and the second code.

### CROSS-REFERENCE TO RELATED APPLICATION

This application is based upon and claims the benefit of priority of the prior Japanese Patent Application No. 2015-140891, filed on Jul. 14, 2015, the entire contents of which are incorporated herein by reference.

### FIELD

The embodiments discussed herein are related to an information processing apparatus and a compile method.

### BACKGROUND

Conventionally, there is a compile technique that generates a computer executable object code based on a source code in which processing contents of software are described using a programming language. Further, there is an optimization technique that changes processing contents described in a source code so as to decrease a processing time of software and decreases an amount of operation within a range in which functionalities specified in the source code are not changed.

As the related art, there is a technique that optimizes referencing of an array having non-linear subscripts in a multi-loop, for example. In addition, for example, there is a technique of performing an analysis of an array element which is redundantly defined in a loop and excluding redundant definition of the array element in the loop. Furthermore, for example, there is a technique that provides a data division method of enhancing execution performance in a case where a sequential program is transformed into a program for a distributed storing type parallel device.

Japanese Laid-open Patent Publication No. 5-143358, Japanese Laid-open Patent Publication No. 4-25942, and Japanese Laid-open Patent Publication No. 7-253955 are examples of the related art.

In the related art described above, however, it may be difficult to optimize software by reducing an amount of operation of software. For example, regarding a multi-loop including an expression in which a contraction operation is performed, there is a case where it is not known how to change processing contents in order to decrease the amount of operation, and it is not possible to decrease the processing time for software.

An aspect of the present disclosure is to provide an information processing apparatus and a compile method capable of optimizing software by reducing an amount of operation of software.

### SUMMARY

According to an aspect of the embodiments, an information processing apparatus includes a memory; and one or more processors coupled to the memory and configured to specify a loop portion in which computation regarding a first expression, which performs a contraction operation with respect to a first variable, is repeated, in a first program code of software, generate a first code in which computation regarding a second expression, which performs a contraction operation on a sub-expression of the first expression with respect to a second variable, is repeated and a second code in which computation regarding a third expression, where the sub-expression of the first expression is replaced with the second variable, is repeated, and output a second program code in which the loop portion of the first program code is transformed into the first code and the second code.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating Example of a compile method according to Embodiment 1;

FIG. 2 is a block diagram illustrating an example of a hardware configuration of an information processing apparatus according to Embodiment 1;

FIG. 3 is a block diagram illustrating an example of a functional configuration of the information processing apparatus according to Embodiment 1;

FIG. 4 is an explanatory diagram illustrating an example of a source code;

FIG. 5 is an explanatory diagram illustrating an example of detection of a multi-loop;

FIG. 6 is an explanatory diagram illustrating an example of address allocation;

FIG. 7 is an explanatory diagram illustrating an example of detection of a contraction operation loop portion (first diagram);

FIG. 8 is an explanatory diagram illustrating the example of the detection of the contraction operation loop portion (second diagram);

FIG. 9 is an explanatory diagram illustrating an example of extraction of a sub-expression (first diagram);

FIG. 10 is an explanatory diagram illustrating the example of the extraction of the sub-expression (second diagram);

FIG. 11 is an explanatory diagram illustrating the example of the extraction of the sub-expression (third diagram);

FIG. 12 is an explanatory diagram illustrating the example of the extraction of the sub-expression (fourth diagram);

FIG. 13 is an explanatory diagram illustrating the example of the extraction of the sub-expression (fifth diagram);

FIG. 14 is an explanatory diagram illustrating of the extraction of the sub-expression (sixth diagram);

FIG. 15 is an explanatory diagram illustrating an example of classification of a scalar variable;

FIG. 16 is an explanatory diagram illustrating an example of calculation of an amount of operation to be decreased (first diagram);

FIG. 17 is an explanatory diagram illustrating an example of the calculation of the amount of operation to be decreased (second diagram);

FIG. 18 is an explanatory diagram illustrating an example of an optimization of the source code;

FIG. 19 is a flowchart illustrating an example of a procedural sequence of a compile process;

FIG. 20 is a flowchart illustrating an example of a procedural sequence of a loop split process;

FIG. 21 is a flowchart illustrating an example of a procedural sequence of a sub-expression extraction process;

FIG. 22 is a flowchart illustrating an example of a procedural sequence of an extraction core-process (first flowchart);

FIG. 23 is a flowchart illustrating the example of the procedural sequence of the extraction core-process (second flowchart);

FIG. 24 is a flowchart illustrating the example of the procedural sequence of the extraction core-process (third flowchart);

FIG. 25 is a flowchart illustrating an example of a procedural sequence of an extraction sub-process;

FIG. 26 is a flowchart illustrating an example of a procedural sequence of a divided sub-expression generation process;

FIG. 27 is a flowchart illustrating an example of a procedural sequence of a variable classification process (first flowchart);

FIG. 28 is a flowchart illustrating the example of the procedural sequence of the variable classification process (second flowchart);

FIG. 29 is a flowchart illustrating an example of a procedural sequence of a first parameter extraction process;

FIG. 30 is a flowchart illustrating an example of a procedural sequence of a second parameter extraction process;

FIG. 31 is a flowchart illustrating an example of a procedural sequence of a third parameter extraction process;

FIG. 32 is a flowchart illustrating an example of a procedural sequence of a contractible variable extraction process;

FIG. 33 is a flowchart illustrating an example of a procedural sequence of a reduction amount calculation process;

FIG. 34 is a flowchart illustrating an example of a procedural sequence of a calculation sub-process (first flowchart);

FIG. 35 is a flowchart illustrating the example of the procedural sequence of the calculation sub-process (second flowchart);

FIG. 36 is a flowchart illustrating the example of the procedural sequence of the calculation sub-process (third flowchart);

FIG. 37 is a flowchart illustrating an example of a procedural sequence of an optimization target determination process;

FIG. 38 is a flowchart illustrating an example of a procedural sequence of an AST deformation process;

FIG. 39 is a flowchart illustrating an example of a procedural sequence of a contraction operation expression insertion process;

FIG. 40 is a flowchart illustrating an example of a procedural sequence of a deformation sub-process;

FIG. 41 is an explanatory diagram illustrating Example of a compile method according to Embodiment 2;

FIG. 42 is an explanatory diagram illustrating an example of a source code according to Embodiment 2;

FIG. 43 is an explanatory diagram illustrating an example of canonicalization of a sub-expression (first explanatory diagram);

FIG. 44 is an explanatory diagram illustrating the example of the canonicalization of the sub-expression (second explanatory diagram);

FIG. 45 is an explanatory diagram illustrating an example of the canonicalization of the sub-expression (third explanatory diagram);

FIG. 46 is an explanatory diagram illustrating an example of specifying of a common sub-expression;

FIG. 47 is an explanatory diagram illustrating an example of optimization of the source code; and

FIG. 48 is a flowchart illustrating an example of a procedural sequence of a reduction amount calculation process according to Embodiment 2.

### DESCRIPTION OF EMBODIMENTS

Hereinafter, embodiments of an information processing apparatus, a compile method, and a compile program according to the present disclosure is described in detail with reference to the accompanying drawings.

### Example of Compile Method According to Embodiment 1

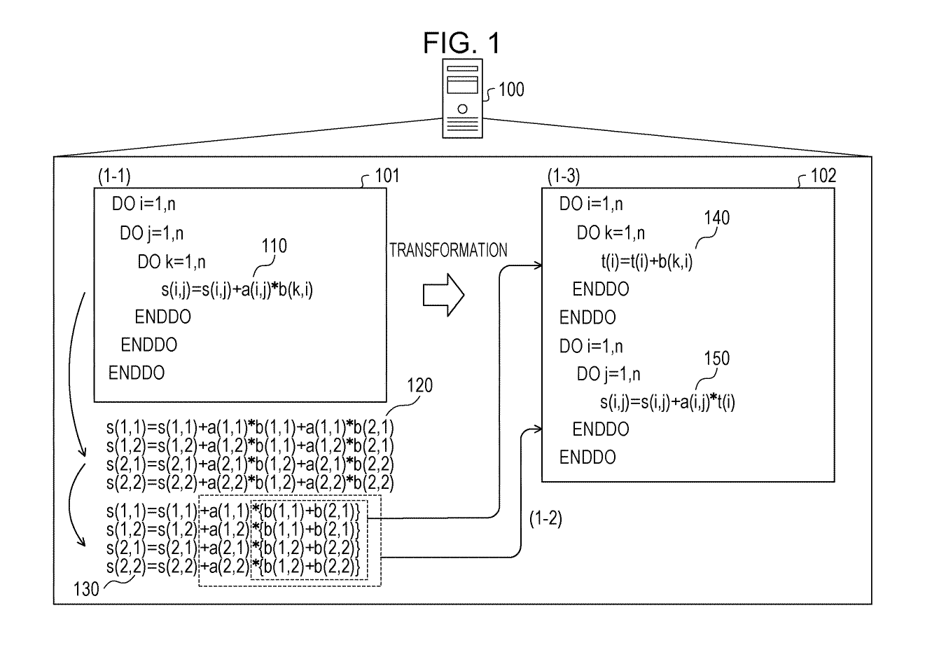

FIG. 1 is a diagram for explaining Example of a compile method according to Embodiment 1. In FIG. 1, an information processing apparatus 100 is a computer that changes processing contents described in a program code within a range in which functionalities specified in the program code are not changed and decreases an amount of operation during execution of software. The program code is a source code 101, for example.

There is an optimization technique of transforming a program code so as to improve predetermined performance regarding software during compilation. The predetermined performance includes, for example, a processing time, a memory use amount, and power consumption at the time of software execution. As the optimization technique, there is a technique of reducing an amount of operation at the time of software execution by reducing an amount of operation of a loop process to achieve reduction of the processing time at the time of software execution. The loop process is a process that repeatedly executes processing within a loop body according to repeating conditions. As a specific optimization technique, there is a technique in which a computation for an expression capable of being handled as a constant is performed outside a loop process when the expression is present in a loop body in a single loop process, and the expression is replaced with the computed result in the loop process.

However, even though the expression capable of being handled as a constant is included in a collection of expressions computed through a plurality of loop processes of a multi-loop process of a nest structure in which an expression performing contraction operation is included, the optimization technique described above is unable to be applied. Accordingly, there is a case where it is not known how to change processing contents in order to decrease the amount of operation and it is not possible to decrease the processing time for software, regarding a multi-loop process which includes an expression performing the contraction operation.

In the present embodiment, description is made on a compile method for changing processing contents and reducing an amount of operation at the time of software execution, regarding the multi-loop process in which the expression performing the contraction operation is included, thereby achieving reduction of the processing time of software. The contraction operation is computation that contracts a plurality of data values into a single data value. The contraction operation includes, for example, addition, multiplication, maximum value computation, minimum value computation, or the like.

In the example of FIG. 1, description is made on an operation of the information processing apparatus 100 by using the source code 101 in which a loop portion, where the computation regarding an expression 110 “s(i,j)=s(i,j)+a(i,j)*b(k,i)” is repeated, is described as an example of a program code.

The expression 110 is an expression which performs the contraction operation on a variable “a(i,j)” or a variable “b(k,i)” with respect to a first variable “s(i,j)”. The symbol “=” is an assignment operator. Here, for example, in a case of n=2, first processing contents in which the computation regarding the expression 110 is repeated in the loop portion is equivalent to second processing contents in which the computation regarding the following expressions (1) to (4) denoted by a reference numeral 120 is performed.

s(1,1)=s(1,1)+a(1,1)*b(1,1)+a(1,1)*b(2,1) (1)

s(1,2)=s(1,2)+a(1,2)*b(1,1)+a(1,2)*b(2,1) (2)

s(2,1)=s(2,1)+a(2,1)*b(1,2)+a(2,1)*b(2,2) (3)

s(2,2)=s(2,2)+a(2,2)*b(1,2)+a(2,2)*b(2,2) (4)

The second processing contents described above may be changed into third processing contents in which the computation regarding the following expressions (5) to (8) denoted by a reference numeral 130 is performed without changing functionalities according to the commutative law, the distributive law, and the associative law of four arithmetic operations. With this, in the third processing contents, the number of operators is decreased to be less than that of the second processing contents and thus, the amount of operation is decreased.

s(1,1)=s(1,1)+a(1,1)*{b(1,1)+b(2,1)} (5)

s(1,2)=s(1,2)+a(1,2)*{b(1,1)+b(2,1)} (6)

s(2,1)=s(2,1)+a(2,1)*{b(1,2)+b(2,2)} (7)

s(2,2)=s(2,2)+a(2,2)*{b(1,2)+b(2,2)} (8)

Furthermore, since the third processing contents described above perform computation regarding the expression having the same content, which is capable of being handled as a constant, without changing functionalities, the third processing contents may be changed into fourth processing contents in which the computation regarding the following expressions (5) to (8) is performed using the results obtained by the computation. For example after performing the computation regarding the expression “b(1,1)+b(2,1)” or the expression “b(1,2)+b(2,2)”, the computation regarding the expressions (5) to (8) is performed using the result obtained by the computation. With this, in the fourth processing contents, the computation regarding the expression having the same content, which is capable of being handled as a constant, may not be performed plural times and thus, the amount of operation is decreased.

In this manner, in a case where an expression capable of being handled as a constant is included among a collection of the expressions computed through a plurality of loop processes, the amount of operation may be decreased if the processing contents described in the source code 101 are changed. Therefore, the information processing apparatus 100 transforms the loop portion of the source code 101 such that reduction of the amount of operation by the change of the processing contents described above is implemented, and outputs a source code 102 after the transformation.

<(1-1) In the Example of FIG. 1>

The information processing apparatus 100 acquires the source code 101. Next, the information processing apparatus 100 performs lexical analysis and grammar analysis with respect to the source code 101 and prepares an abstract syntax tree corresponding to the source code 101. The information processing apparatus 100 specifies, based on the abstract syntax tree, a loop portion in which the computation regarding the expression 110 “s(i,j)=s(i,j)+a(i,j)*b(k,i)”, which is described in the source code 101, is repeated.

<(1-2) In the Example of FIG. 1>

The information processing apparatus 100 generates a first code in which the computation regarding an expression 140 “t(i)=t(i)+b(k,i)”, which performs the contraction operation on a sub-expression “b(k,i)” of the expression 110 with respect to a second variable “t(i)”, is repeated. The first code is a code corresponding to the processing contents in which the computation regarding the expression “b(1,1)+b(2,1)” or the expression “b(1,1)+b(2,2)” described above is performed. A second variable is a variable for temporarily storing an operation result.

The information processing apparatus 100 generates a second code in which the computation regarding an expression 150 “s(i,j)=s(i,j)+a(i,j)*t(i)”, where the sub-expression of the expression 110 is replaced with the second variable, is repeated. The second code is a code corresponding to the processing contents in which the computation regarding the expressions (5) to (8) is performed using the result obtained by the computation regarding the expression “b(1,1)+b(2,1)” or the expression “b(1,1)+b(2,2)”.

<(1-3) In the Example of FIG. 1>

The information processing apparatus 100 transforms the loop portion of the source code 101 into the first code and the second code. The information processing apparatus 100 outputs the source code 102 after the transformation to a display device and transmits the source code 102 to another computer or stores the source code 102 in a storage device. As a result, the information processing apparatus 100 or another computer becomes able to compile the source code 102 and prepare an object code.

In this manner, according to the information processing apparatus 100, it is possible to generate the first code which indicates the loop process including the expression 140 which performs the contraction operation on a sub-expression of the expression 110 with respect to the second variable and the second code which indicates the loop process including the expression 150 in which the sub-expression is replaced with the second variable. According to the information processing apparatus 100, it is possible to transform the loop portion including the expression 110 which performs the contraction operation into the first code and the second code. With this, the information processing apparatus 100 may transform the source code 101 such that the expression 140 is prepared using an expression, which is included in a collection of expressions computed through a plurality of loop process and is capable of being handled as a constant, and the computation regarding the expression 140 is performed in advance.

As a result, the information processing apparatus 100 may decrease the amount of operation during software execution and achieve a reduction of the processing time of software. For example, in the source code 101, an addition “+” and a multiplication “*” are repeatedly executed “n̂3” times and thus, the amount of operation is “2n̂3”. In contrast, in the source code 102 after the transformation, an addition “+” is executed “n̂2” times and an addition “+” and multiplication “*” are executed “n̂2” times and thus, the amount of operation is “n̂2+2n̂2”. As a result, in the source code 102 after the transformation, if n>2, the amount of operation is decreased.

Here, although description has been made on a case where the information processing apparatus 100 specifies the loop portion based on the abstract syntax tree, the present disclosure is not limited thereto. For example, the information processing apparatus 100 may specify the loop portion from the source code 101 without preparing the abstract syntax tree. Although description has been made on a case where the information processing apparatus 100 transforms the source code 101, the present disclosure is not limited thereto. For example, the information processing apparatus 100 may transform an abstract syntax tree corresponding to the source code 101 into an abstract syntax tree corresponding to the source code 102 and output the abstract syntax tree.

<<Example of Hardware Configuration of Information Processing Apparatus 100 According to Embodiment 1>>

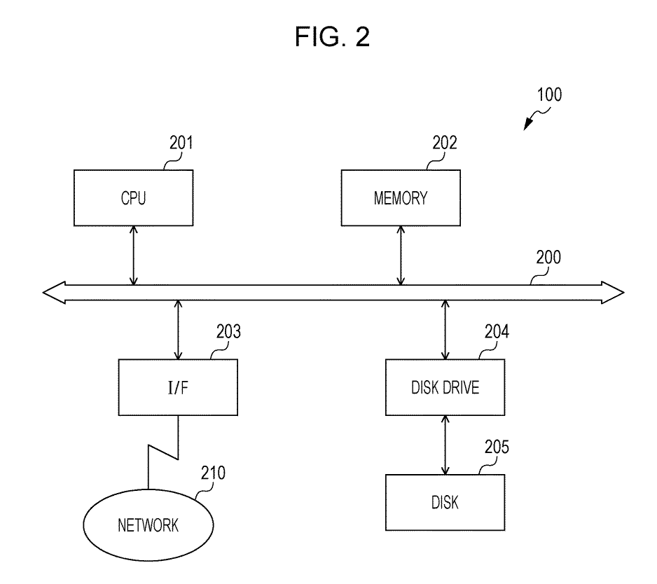

Next, an example of a hardware configuration of the information processing apparatus 100 according to Embodiment 1 is described using FIG. 2.

FIG. 2 is a block diagram illustrating an example of a hardware configuration of an information processing apparatus 100 according to Embodiment 1. In FIG. 2, the information processing apparatus 100 includes a central processing unit (CPU) 201, a memory 202, an interface (I/F) 203, a disk drive 204, a disk 205, and the like. The respective components are connected with each other through a bus 200.

The CPU 201 controls the entire information processing apparatus 100. The memory 202 includes, for example, a read only memory (ROM), a random access memory (RAM), a flash ROM and the like. Specifically, for example, the flash ROM or the ROM stores various programs and the RAM is used as a work area of the CPU 201. The program stored in the memory 202 is loaded onto the CPU 201 and causes the CPU 201 to execute processing code. The CPU may include one or more processors.

The I/F 203 is connected to a network 210 through a communication line and connected to another computer through the network 210. The I/F 203 manages internal interface with the network 210 and controls input and output of data to and from the other computer. For example, a modem, a local area network (LAN) adaptor, or the like may be adopted in the I/F 203.

The disk drive 204 controls data read/data write for the disk 205 according to the control of the CPU 201. The disk drive 204 is, for example, a magnetic disk drive. The disk 205 is a non-volatile memory storing data written by the control of the disk drive 204. The disk 205 is, for example, a magnetic disk, an optical disk and the like.

The information processing apparatus 100 may include, for example, a solid state drive (SSD), a semiconductor memory, a keyboard, a mouse, a display and the like, in addition to the components described above. The information processing apparatus 100 may include, for example, the SSD and the semiconductor memory, instead of the disk drive 204 and the disk 205.

<<Example of Functional Configuration of Information Processing Apparatus 100 According to Embodiment 1>>

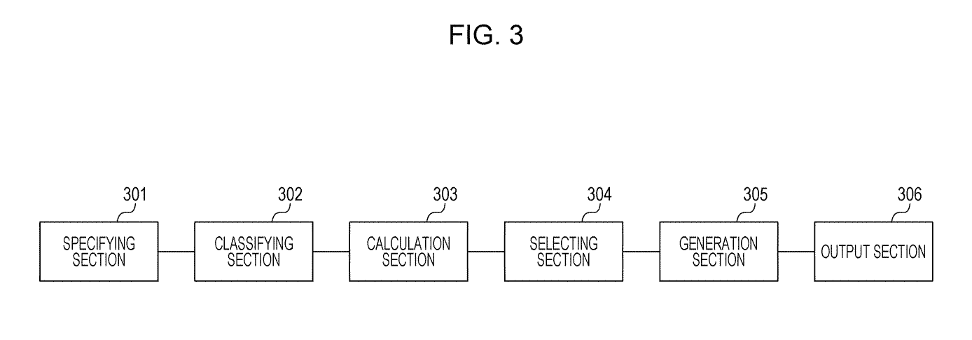

Next, an example of a functional configuration of the information processing apparatus 100 according to Embodiment 1 is described using FIG. 3.

FIG. 3 is a block diagram illustrating an example of a functional configuration of the information processing apparatus 100 according to Embodiment 1. The information processing apparatus 100 includes a specifying section 301, a classifying section 302, a calculation section 303, a selecting section 304, a generation section 305, and an output section 306.

The specifying section 301 to the output section 306 are functionalities serving as a control section and the functionalities are implemented, for example, by causing the CPU 201 to execute a program stored in the memory 202 and the disk 205 illustrated in FIG. 2 or by the I/F 203. The processing results of the respective functional sections are stored, for example, in the memory 202 and the disk 205 illustrated in FIG. 2.

The specifying section 301 specifies a loop portion in which the computation regarding a first expression, which performs the contraction operation with respect to a first variable, is repeated, in a program code of software. The program code is, for example, a code describing the processing contents of software. The program code is, for example, a source code. The program code may be a code representing an abstract syntax tree. The first expression is an expression which performs the contraction operation on a plurality of terms or arguments with respect to the first variable using the first operator. The loop portion is, for example, a portion where a plurality of statements of a nest structure and a loop body are described.

The specifying section 301 specifies, for example, a loop portion in which the computation regarding the first expression “s(i,j)=s(i,j)+a(i,j)*b(k,i)”, which performs the contraction operation with respect to the first variable “s(i,j)”, is repeated, among a source code. With this, the specifying section 301 may specify the loop portion having a possibility that the amount of operation during software execution is decreased.

The classifying section 302 classifies variables used in a condition to repeat the computation regarding the first expression into a first type variable and a second type variable different from the first type variable in each sub-expression of the first expression. The sub-expression is a portion of a unit sub-expression on which the contraction operation is performed with respect to the first variable. The portion of a unit sub-expression may be the unit sub-expression itself in a case where the unit sub-expression is handled as “1*unit sub-expression”.

The first type variable is a variable which coincides with any of a variable used for an index of the first variable, a variable used in a condition to repeat the computation regarding the expression which performs initialization of the first variable, and a variable used for an index which is common to the sub-expression and remaining sub-expressions of the unit sub-expression. In the following description, the first type variable may be denoted as a “parameter”. Further, in the following description, the second type variable may be denoted as a “contractible variable”.

The classifying section 302 classifies variables “i, j, and k” used in a condition to repeat the computation regarding the first expression into a parameter and a contractible variable in the sub-expression “b(k,i)” of the first expression. Specifically, the classifying section 302 specifies the indexes i and j of the first variable “s(i, j)”. The classifying section 302 specifies the variables i and j used in a condition to repeat the computation regarding the expression which performs initialization of the first variable “s(i, j)”. The classifying section 302 specifies the variable i used for an index which is common to the sub-expression “b(k,i)” of the first expression and the remaining sub-expression “a(i,j)” of the unit sub-expression “a(i,j)*b(k,i)” on which the contraction operation is performed with respect to the first expression.

The classifying section 302 classifies the specified variables i and j into the parameter. The classifying section 302 classifies the unspecified variable k into a contractible variable. With this, the classifying section 302 may obtain information used when the amount of operation, which is decreased in a case of transforming the loop portion specified by the specifying section 301 based on the sub-expression of the first expression, is calculated.

The calculation section 303 specifies a type and the number of repetition times of the computation regarding the second expression, which performs the contraction operation on each sub-expression with respect to the second variable, regarding each sub-expression of the first expression. The second expression is an expression which performs the contraction operation on the sub-expression with respect to the second variable by a first operator. The calculation section 303 specifies a type and the number of repetition times of the computation regarding the third expression in which the sub-expression of the first expression is replaced by the second variable. The calculation section 303 calculates a difference between an amount of operation for the loop portion and a total of an amount of operation for the repetition of the computation regarding the second expression and an amount of operation for the repetition of the computation regarding the third expression, based on the specified type and the number of repetition times.

The calculation section 303 specifies a type and the number of repetition times of the computation regarding the second expression which performs the contraction operation on each sub-expression with respect to the second variable, regarding each sub-expression of the first expression, based on the classified first type variable and second type variable. The calculation section 303 specifies a type and the number of repetition times of the computation regarding the third expression in which the sub-expression of the first expression is replaced with the second variable, regarding each sub-expression of the first expression, based on the classified first type variable and second type variable.

The calculation section 303 calculates a value obtained by multiplying the number of operators for each specified type regarding the second expression and the number of repetition times as an amount of operation for the repetition of the computation regarding the second expression. The calculation section 303 calculates a value obtained by multiplying the number of operators for each specified type regarding the third expression and the number of repetition times as an amount of operation for the repetition of the computation regarding the third expression. The calculation section 303 calculates a difference between an amount of operation for the loop portion and a total of an amount of operation for the repetition of the computation regarding the second expression and an amount of operation for the repetition of the computation regarding the third expression.

Specifically, the calculation section 303 specifies the variables “k, i” which become an index of the sub-expression “b(k,i)” of the first expression among the parameters “i, j” and the contractible variable “k”. Next, the calculation section 303 calculates a value “n̂2” obtained by multiplying the number of repetition times regarding the variables “k, i” in the loop portion as the number of repetition times “n̂2” regarding the second expression.

If the contractible variable “k” is included in the variables “k, i” which become an index of the sub-expression “b(k,i)” of the first expression, the calculation section 303 specifies a type of computation regarding the second expression “+”. Next, if an operator is included in the sub-expression “b(k,i)” of the first expression, the calculation section 303 specifies the operator as the type of computation regarding the second expression and otherwise, if the operator is not included in the sub-expression “b(k,i)”, the calculation section 303 does not specify the type of computation regarding the second expression.

Next, the calculation section 303 specifies the variables “i, j” which become an index of the remaining sub-expression “a(i,j)” of the parameters “i, j” and the contractible variable “k”. Next, the calculation section 303 calculates a value “n̂2” obtained by multiplying the number of repetition times regarding the variables “i, j” in the loop portion as the number of repetition times “n̂2” regarding the third expression.

Next, if an operator is included in the remaining sub-expression “a(i,j)”, the calculation section 303 specifies the operator as the type of computation regarding the third expression and otherwise, if the operator is not included in sub-expression “a(i,j)”, the calculation section 303 does not specify the type of computation regarding the third expression. Furthermore, the calculation section 303 specifies an operator “*” used when binding the second variable and the remaining sub-expression “a(i,j)”. The calculation section 303 specifies an operator “+” used when performing the contraction operation on the bound result.

The calculation section 303 calculates the value “n̂2” obtained by multiplying the number of operators “1” for each type specified regarding the second expression and the number of repetition times as an amount of operation “n̂2” for the repetition of the computation regarding the second expression. Next, the calculation section 303 calculates the value “2n̂2” obtained by multiplying the number of operators “2” for each type specified regarding the third expression and the number of repetition times as an amount of operation “2n̂2” for the repetition of the computation regarding the third expression.

The calculation section 303 calculates an amount of operation “2n̂3” for the loop portion and calculates a difference “2n̂3−3n̂2” between an amount of operation for the loop portion and a total of an amount of operation for the repetition of the computation regarding the second expression and an amount of operation for the repetition of the computation regarding the third expression. With this, the calculation section 303 may calculate the amount of operation decreased in a case of transforming the program code.

Here, although description is made on a case where the amount of operation is equal even when the type of operator is “+” as well as “*”, the present disclosure is not limited thereto. For example, in a case where the amount of operation is different due to the type of the operator, the calculation section 303 may calculate the amount of operation weighted according to the type of the operator. The calculation section 303 may calculate the amount of operation decreased in a case of transforming the program code using a method other than the calculation method described above. The calculation section 303 may calculate an index value relating to the amount of operation to be decreased, instead of the amount of operation to be decreased.

The selecting section 304 selects any of the sub-expressions of the first expression, based on the difference calculated by the calculation section 303. The selecting section 304 selects a sub-expression having the largest difference calculated by the calculation section 303. With this, the selecting section 304 may select a sub-expression used in a case of transforming the program code such that the amount of operation during software execution is decreased to the maximum.

The generation section 305 generates a first code in which computation regarding the second expression, which performs the contraction operation on the sub-expression of the first expression with respect to the second variable, is repeated and a second code in which computation regarding the third expression, where the sub-expression of the first expression is replaced with the second variable, is repeated. The generation section 305 generates, for example, the first code and the second code regarding any of the selected sub-expressions.

The generation section 305 specifies variables and the number of repetition times used in a condition to repeat the computation regarding the second expression that performs the contraction operation on each sub-expression, regarding each sub-expression of the first expression. The generation section 305 specifies variables and the number of repetition times used in a condition to repeat the computation regarding the third expression in which the sub-expression is replaced. The generation section 305 generates the first code using a loop statement and the second code using a loop statement, based on the specified variables and the number of repetition times.

More specifically, the generation section 305 specifies variables and the number of repetition times used in a condition to repeat the computation regarding the second expression that performs the contraction operation on each sub-expression, regarding each sub-expression of the first expression, based on the classified first type variable and second type variable. The generation section 305 specifies variables and the number of repetition times used in a condition to repeat the computation regarding the third expression in which the sub-expression is replaced. The generation section 305 generates the first code using a loop statement and the second code using a loop statement, based on the specified variables and the number of repetition times. With this, the generation section 305 may generate a program code capable of reducing the operation amount during software execution.

The output section 306 outputs a program code after the transformation obtained by transforming the loop portion of the program code into the first code and the second code. For example, the output section 306 displays the program code after the transformation, prints and outputs the program code to a printer, transmits the program code to an external device through the I/F 203, or stores the program code in the storage device such as the memory 202 or the disk 205. With this, the output section 306 may provide the program code after the transformation to a compiler.

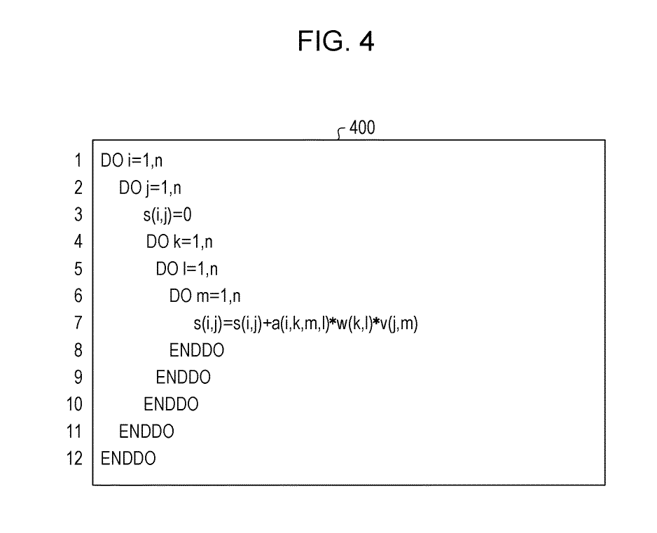

Hereinafter, an example of operations of the information processing apparatus 100 according to Embodiment 1 is described with reference to FIG. 4 to FIG. 18.

<<Example of Source Code 400>>

FIG. 4 is a diagram illustrating an example of a source code 400. The source code 400 is, for example, text data in which contents of processing executed by a computer are described using a programming language such as FORTRAN, C, BASIC, or the like.

In the example of FIG. 4, a loop statement “DO i=1, n (loop body) ENDDO” is described in the first row and the twelfth row of the source code 400. The loop body which is repeatedly executed by the loop statement “DO i=1, n (loop body) ENDDO” is described in a portion from the second row to the eleventh row of the source code 400. With this, contents of the loop process which repeatedly executes the processing within the loop body until the variable i reaches n, where the variable i begins from 1, is described in a portion from the first row to the twelfth row of the source code 400.

A loop statement “DO j=1, n (loop body) ENDDO” is described in the second row and the eleventh row of the source code 400. The loop body which is repeatedly executed by the loop statement “DO j=1, n (loop body) ENDDO” is described in a portion from the third row to the tenth row of the source code 400. With this, contents of the loop process which repeatedly executes the processing within the loop body until the variable j reaches n, where the variable j begins from 1, is described in a portion from the second row to the eleventh row of the source code 400.

An assignment statement “s(i,j)=0” is described in the third row of the source code 400. With this, contents of initialization processing for assigning a numerical value “0” to a value of an array variable s(i,j) is described in the third row of the source code 400.

A loop statement “DO k=1, n (loop body) ENDDO” is described in the fourth row and the tenth row of the source code 400. The loop body which is repeatedly executed by the loop statement “DO k=1, n (loop body) ENDDO” is described in a portion from the fifth row to the ninth row of the source code 400. With this, contents of the loop process which repeatedly executes the processing within the loop body until the variable k reaches n, where the variable k begins from 1, is described in a portion from the fourth row to the tenth row of the source code 400.

A loop statement “DO l=1, n (loop body) ENDDO” is described in the fifth row and the ninth row of the source code 400. The loop body which is repeatedly executed by the loop statement “DO l=1, n (loop body) ENDDO” is described in a portion from the sixth row to the eighth row of the source code 400. With this, contents of the loop process which repeatedly executes the processing within the loop body until the variable l reaches n, where the variable l begins from 1, is described in a portion from the fifth row to the ninth row of the source code 400.

A loop statement “DO m=1, n (loop body) ENDDO” is described in the sixth row and the eighth row of the source code 400. The loop body which is repeatedly executed by the loop statement “DO m=1, n (loop body) ENDDO” is described in the seventh row of the source code 400. With this, contents of the loop process which repeatedly executes the processing within the loop body until the variable m reaches n, where the variable m begins from 1, is described in a portion from the sixth row to the eighth row of the source code 400.

An assignment statement “s(i,j)=s(i,j)+a(i,k,m,l)*w(k,l)*v(j,m)” is described in the seventh row of the source code 400. With this, contents of assignment processing for assigning a value of an array variable s(i,j)+an array variable a(i,k,m,l)*an array variable w(k,l)*an array variable v(j,m) to a value of an array variable s(i,j) are described in the seventh row of the source code 400.

In this manner, a portion from the first row to the twelfth row of the source code 400 is a multi-loop portion in which a collection of a plurality of loop statements having a nest structure is described. The portion from the first row to the third row, the eleventh row, and the twelfth row of the source code 400 is a multi-loop portion in which a collection of a plurality of loop statements having a nest structure is described and which changes the variables i and j, switches an array variable s(i,j) on which the contraction operation is performed, and initializes the switched array variable s(i,j). In the following description, a loop portion in which an array variable s(i,j), on which the contraction operation is performed, is switched and initialized may be denoted as an “initialization loop portion”.

The fourth row to the tenth row of the source code 400 is a multi-loop portion in which a collection of a plurality of loop statements having a nest structure is described and which performs the contraction operation with respect to the initialized array variable s(i,j), by repeating an assignment operation with respect to the initialized array variable s(i,j). In the following description, a loop portion in which the contraction operation is performed may be denoted as a “contraction operation loop portion”.

<<Example of Multi-Loop Detection>>

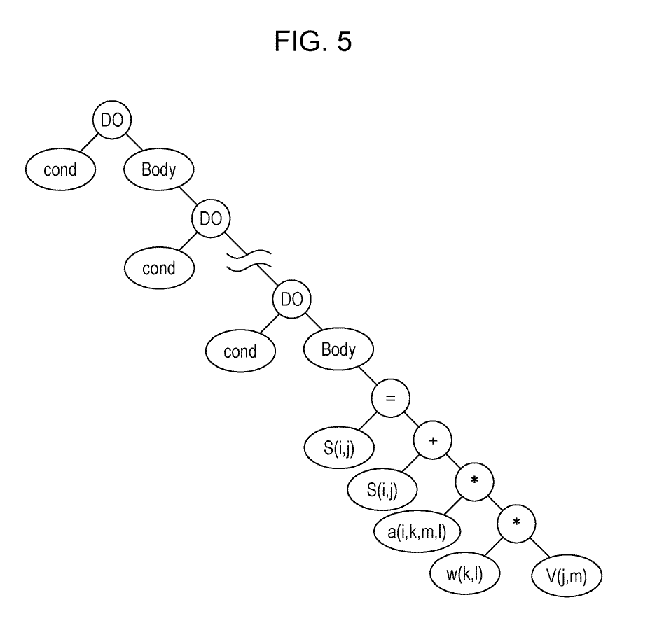

FIG. 5 is a diagram illustrating an example of detection of a multi-loop. In FIG. 5, the information processing apparatus 100 generates an Abstract Syntax Tree, a variable table, a function table and the like based on the source code 400 in FIG. 4. The information processing apparatus 100 detects the multi-loop portion, based on the generated abstract syntax tree. In the following description, the abstract syntax tree may be denoted as an “AST”.

The information processing apparatus 100 generates nodes having a function or control syntax within the source code 400, an argument of the function or control syntax, an instruction sentence within the function, an instruction sentence for a branch destination of the control syntax, a variable or operator within the instruction sentence, or the like as an attribute. As the node, there is a node which has a loop body (Body) as an attribute and to which a child node having an instruction sentence within the loop body as an attribute is connected. As the node, there is a node which has a repetition condition (cond) of the loop statement as an attribute and to which a child node having a variable used in the repetition condition as an attribute is connected. In the example of FIG. 5, for brevity of description, illustration regarding a child node of a cond, a node having an index of the variable as an attribute, or the like will not be repeated.

Next, the information processing apparatus 100 specifies a connection relationship between the generated nodes according to contents of the process described in the source code 400 and connects the generated nodes with each other to thereby generate the abstract syntax tree. The information processing apparatus 100 retrieves a node having a loop statement as an attribute through a node having a loop body as an attribute from a node having a loop statement as an attribute to thereby detect a multi-loop.

<<Example of Address Allocation>>

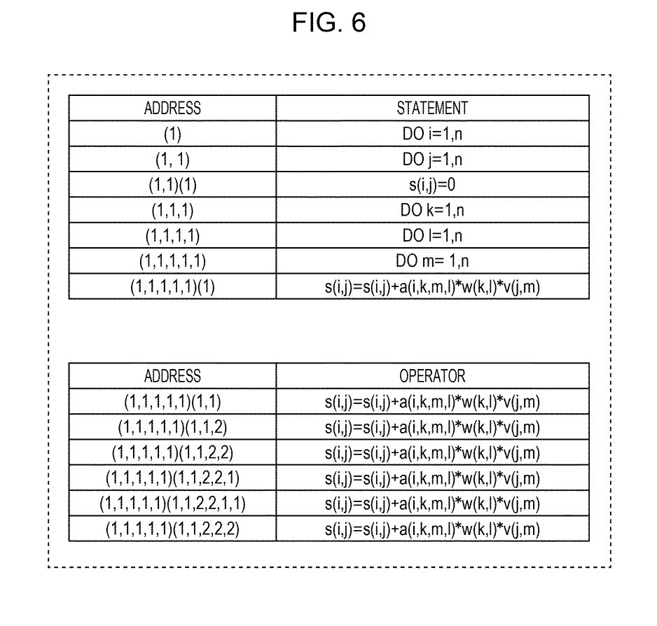

FIG. 6 is a diagram illustrating an example of address allocation. In FIG. 6, the information processing apparatus 100 stores an address of a hierarchical structure corresponding to a nest structure of a plurality of loop statements of a multi-loop portion in a node of an AST corresponding to an instruction statement, an operator, or the like included in a detected multi-loop portion by associating the address with the node.

The information processing apparatus 100, for example, stores an address (1) in a node corresponding to a loop statement “DO i=1, n (loop body) ENDDO” described in the first row of the source code 400 by associating the address (1) with the node. The information processing apparatus 100 stores an address (1, 1) in a node corresponding to a loop statement “DO j=1, n (loop body) ENDDO” described in the second row of the source code 400 by associating the address (1, 1) with the node. The information processing apparatus 100 stores an address (1, 1) (1) in a node corresponding to an assignment statement “s(i,j)=0” described in the third row of the source code 400 by associating the address (1, 1) (1) with the node.

The information processing apparatus 100 associates an address (1, 1, 1, 1, 1) (1, 1) with a node corresponding to an operator “=” used in the seventh row. The information processing apparatus 100 associates an address (1, 1, 1, 1, 1) (1, 1, 2) with a node corresponding to an operator “+” used in the seventh row. Similarly, the information processing apparatus 100 stores an address in a node of an AST corresponding to an instruction statement, an operator, or the like described in the source code 400 by associating the address with the node.

<<Example of Detection of Contraction Operation Loop Portion>>

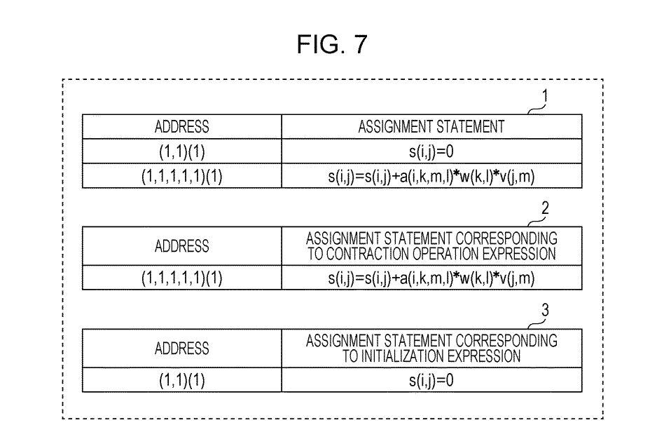

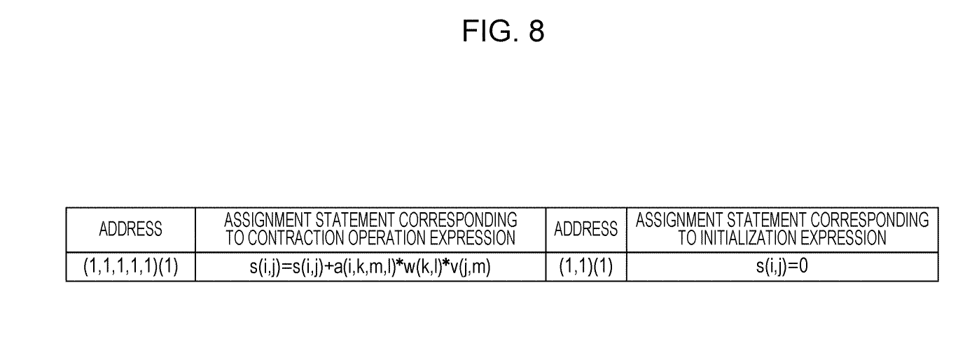

FIG. 7 and FIG. 8 are diagrams for explaining an example of detection of a contraction operation loop portion. In FIG. 7, the information processing apparatus 100 generates the list 1 storing the assignment statement. The information processing apparatus 100 extracts assignment statements included in the detected multi-loop portion and classifies the extracted assignment statements for each variable of the left side and adds the extracted assignment statement to a list 1 to thereby update the list 1.

Next, the information processing apparatus 100 generates a list 2 storing an assignment statement corresponding to an expression which performs the contraction operation, specifies an assignment statement corresponding to a contraction operation format “r=r+(expression including no r)” of the extracted assignment statements, and adds the specified assignment statement to a list 2 to thereby update the list 2. In the following description, an expression which performs the contraction operation may be denoted as a “contraction operation expression”.

The information processing apparatus 100 generates a list 3 storing an assignment statement corresponding to an expression which performs initialization and adds the assignment statement, which is included in the list 1 and not included in the list 2, to a list 3 to thereby update the list 3. In the following description, an expression which performs initialization may be denoted as an “initialization expression”.

The information processing apparatus 100 adds, for example, an assignment statement “s(i,j)=0” which is associated with an address (1, 1) (1) to the list 1. The information processing apparatus 100 adds, for example, an assignment statement “s(i,j)=s(i,j)+a(i,k,m,l)*w(k,l)*v(j,m)” which is associated with an address (1, 1, 1, 1, 1) (1) to the list 1.

Next, the information processing apparatus 100 adds, for example, an assignment statement “s(i,j)=s(i,j)+a(i,k,m,l)*w(k,l)*v(j,m)” which is associated with an address (1, 1, 1, 1, 1) (1) to the list 2. The information processing apparatus 100 adds, for example, an assignment statement “s(i,j)=0” which is associated with an address (1, 1) (1) to the list 3.

In FIG. 8, the information processing apparatus 100 generates a list 4 which stores a contraction operation and an initialization expression with respect to the same variable by associating the contraction expression with the initialization expression and adds elements of the list 2 and the list 3 by associating the elements with each other 2 to thereby update the list 4. Next, the information processing apparatus 100 specifies the element which coincides with an address of the list 3 and the element which does not coincide with the address of the list 3 that are stored in the list 4, of the addresses of the list 2. The information processing apparatus 100 specifies, based on the specified elements, a contraction operation loop portion on which the contraction operation with respect to a single scalar variable is performed in the multi-loop portion.

The information processing apparatus 100 specifies that, for example, elements coincident with the address (1, 1) of the list 3 are the first and second elements of the address 1 of the list 2, of the address (1, 1, 1, 1, 1) of the list 2. The information processing apparatus 100 specifies that the loop statement corresponding to the first and second elements of the address of the list 2 is the initialization loop portion initializing the scalar variable in the collection of the loop statements which switches the scalar variable on which the contraction operation is performed.

The information processing apparatus 100 specifies elements that are not coincident with the address (1, 1) of the list 3, which are the third to fifth elements of the address of the list 2, of the address (1, 1, 1, 1, 1) of the list 2. The information processing apparatus 100 specifies that the loop statement corresponding to the third to fifth elements of the address of the list 2 is the contraction operation loop portion on which the contraction operation is performed in the collection of the loop statements which performs the contraction operation with respect to the initialized scalar variable.

<<Example of Extraction of Sub-Expression>>

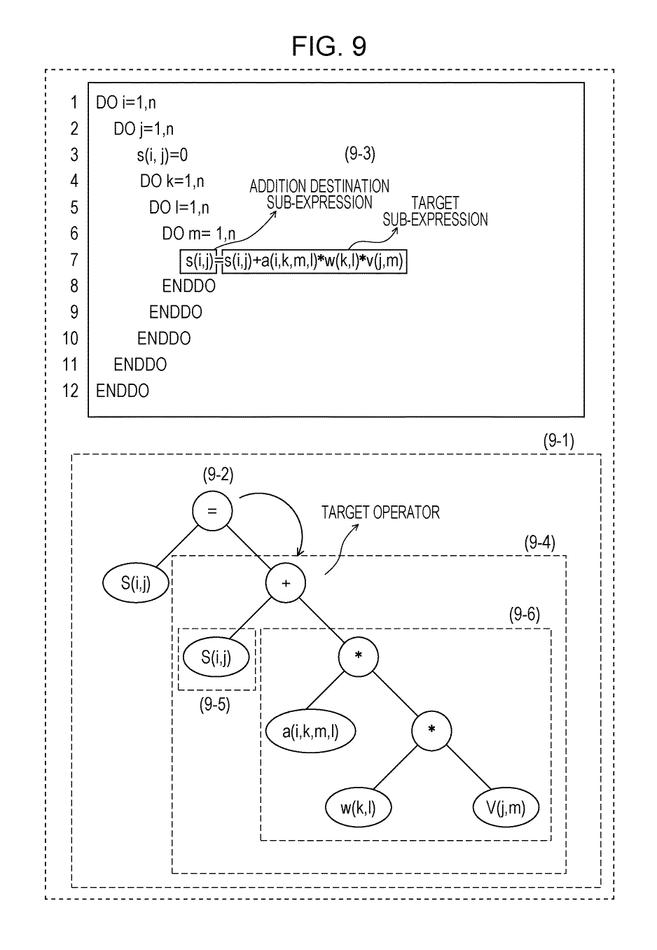

FIG. 9 to FIG. 14 are diagrams for explaining an example of extraction of a sub-expression. In FIG. 9, the information processing apparatus 100 stores an address associated with an assignment statement and a sub-expression included in the assignment statement by associating the address with the sub-expression and generates a list 5 of sub-expressions.

<(9-1) In the Example of FIG. 9>

The information processing apparatus 100 extracts a partial tree corresponding to an assignment statement “s(i,j)=s(i,j)+a(i,k,m,l)*w(k,l)*v(j,m)” used for the contraction operation of an abstract syntax tree.

<(9-2) In the Example of FIG. 9>

The information processing apparatus 100 refers to a root node of the extracted partial tree. Since the operator serving as the attribute of the root node is “=”, the information processing apparatus 100 refers to a child node corresponding to the right side of the contraction operation expression. Since the operator serving as the attribute of the child node is “+”, the information processing apparatus 100 sets the operator “+” as a target operator.

<(9-3) In the Example of FIG. 9>

The information processing apparatus 100 sets the right side “s(i,j)+a(i,k,m,l)*w(k,l)*v(j,m)” of the contraction operation expression as a target sub-expression. The information processing apparatus 100 sets the left side “s(i,j)” of the contraction operation expression as an addition destination sub-expression.

<(9-4) In the Example of FIG. 9>

The information processing apparatus 100 refers to a root node of the partial tree corresponding to the target sub-expression. Since the operator serving as the attribute of the root node is “+” and coincides with the target operator “+”, the information processing apparatus 100 selects one of the child nodes. The information processing apparatus 100 sets the expression “s(i,j)” corresponding to the partial tree, in which the selected child node serves as a root, as the target sub-expression.

<(9-5) In the Example of FIG. 9>

Since the target sub-expression “s(i,j)” coincides with the addition destination sub-expression, the information processing apparatus 100 selects the other child node which is not selected at (9-4). The information processing apparatus 100 sets the expression “a(i,k,m,l)*w(k,l)*v(j,m)” corresponding to the partial tree, in which the selected child node serves as a root, as the target sub-expression.

<(9-6) In the Example of FIG. 9>

The information processing apparatus 100 refers to the root node of the partial tree corresponding to the target sub-expression. Since the operator serving as the attribute of the root node is “*” and does not coincide with the target operator “+” and the target sub-expression “a(i,k,m,l)*w(k,l)*v(j,m)” does not coincide with the addition destination sub-expression, the information processing apparatus 100 adds the target sub-expression to the list 5.

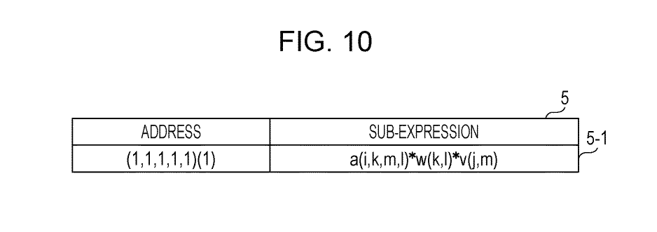

As illustrated in FIG. 10, the list 5, for example, stores a recode 5-1 in which the target sub-expression “a(i,k,m,l)*w(k,l)*v(j,m)” is associated with the address (1,1,1,1,1) (1) corresponding to the contraction operation expression.

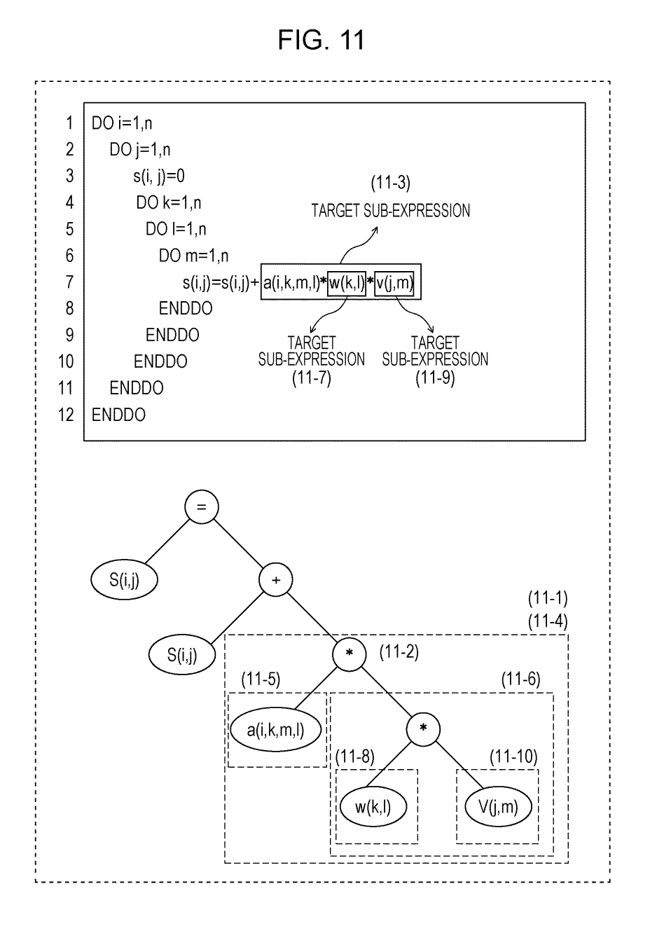

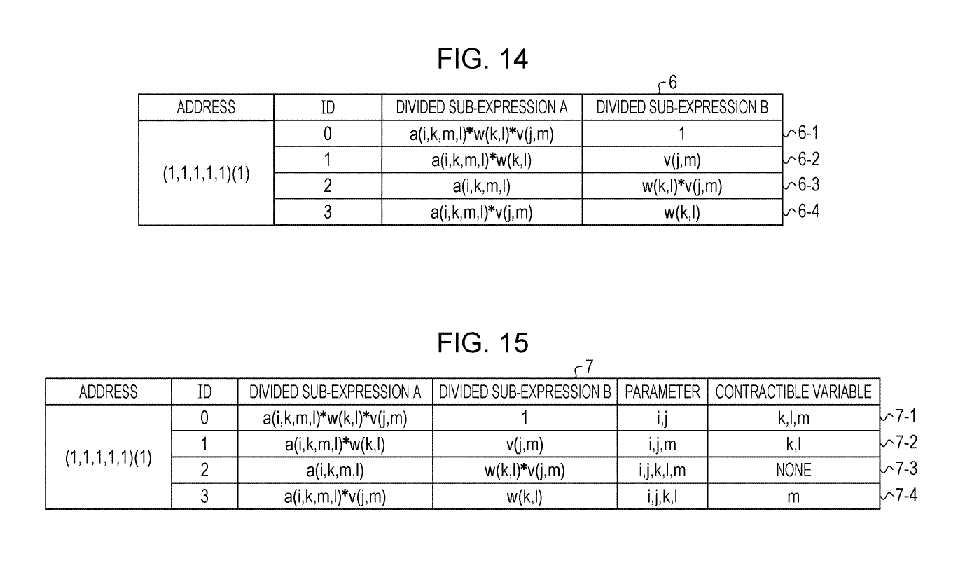

In FIG. 11, the information processing apparatus 100 generates a list 6 of the divided sub-expressions, which stores the address which is in association with the assignment statement and a combination of divided sub-expressions obtained by dividing the sub-expression included in the assignment statement into two sub-expressions by associating the address with the combination, and updates the list 6. The stored contents of the list 6 are described later with reference to FIG. 14.

<(11-1) In the Example of FIG. 11>

The information processing apparatus 100 extracts the sub-expression “a(i,k,m,l)*w(k,l)*v(j,m)” from the list 5 and sets the sub-expression as the current sub-expression. The information processing apparatus 100 adds a combination of the current sub-expression “a(i,k,m,l)*w(k,l)*v(j,m)” and the numerical value “1” to the list 6 and updates the list 6.

The information processing apparatus 100 generates a list 5′ of the sub-expression, which stores the address which is in association with the assignment statement and the sub-expression included in the assignment statement by associating the address with the sub-expression.

<(11-2) In the Example of FIG. 9>

The information processing apparatus 100 refers to a root node of a partial tree corresponding to the current sub-expression. Since the operator serving as the attribute of the root node is a binary operator “*”, the information processing apparatus 100 sets the operator “*” as the target operator.

<(11-3) In the Example of FIG. 9>

The information processing apparatus 100 sets the current sub-expression “a(i,k,m,l)*w(k,l)*v(j,m)” as the target sub-expression. The information processing apparatus 100 sets “NULL” as an addition destination sub-expression.

<(11-4) In the Example of FIG. 9>

The information processing apparatus 100 refers to a root node of the partial tree corresponding to the target sub-expression. Since the operator serving as the attribute of the root node is “*” and coincides with the target operator “*”, the information processing apparatus 100 selects one of the child nodes. The information processing apparatus 100 sets the expression “a(i,k,m,l)” corresponding to the partial tree, in which the selected child node serves as a root, as the target sub-expression.

<(11-5) In the Example of FIG. 9>

The information processing apparatus 100 refers to the root node of the partial tree corresponding to the target sub-expression “a(i,k,m,l)”. Since the attribute of the root node is not an operator and the target sub-expression “a(i,k,m,l)” does not coincide with the addition destination sub-expression, the information processing apparatus 100 adds the target sub-expression to the list 5′.

<(11-6) In the Example of FIG. 9>

The information processing apparatus 100 selects the other child node which is not selected at (11-4). The information processing apparatus 100 sets the expression “w(k,l)*v(j,m)” corresponding to the partial tree, in which the selected child node serves as a root, as the target sub-expression.

<(11-7) In the Example of FIG. 9>

The information processing apparatus 100 refers to a root node of the partial tree corresponding to the target sub-expression. Since the operator serving as the attribute of the root node is “*” and coincides with the target operator “*”, the information processing apparatus 100 selects one of the child nodes. The information processing apparatus 100 sets the expression “w(k,l)” corresponding to the partial tree, in which the selected child node serves as a root, as the target sub-expression.

<(11-8) In the Example of FIG. 9>

The information processing apparatus 100 refers to the root node of the partial tree corresponding to the target sub-expression. Since the attribute of the root node is not an operator and the target sub-expression “w(k,l)” does not coincide with the addition destination sub-expression, the information processing apparatus 100 adds the target sub-expression to the list 5′.

<(11-9) In the Example of FIG. 9>

The information processing apparatus 100 selects the other child node which is not selected at (11-7). The information processing apparatus 100 sets the expression “v(j,m)” corresponding to the partial tree, in which the selected child node serves as a root, as the target sub-expression.

<(11-10) In the Example of FIG. 9>

The information processing apparatus 100 refers to the root node of the partial tree corresponding to the target sub-expression. Since the attribute of the root node is not an operator and the target sub-expression “v(j,m)” does not coincide with the addition destination sub-expression, the information processing apparatus 100 adds the target sub-expression to the list 5′.

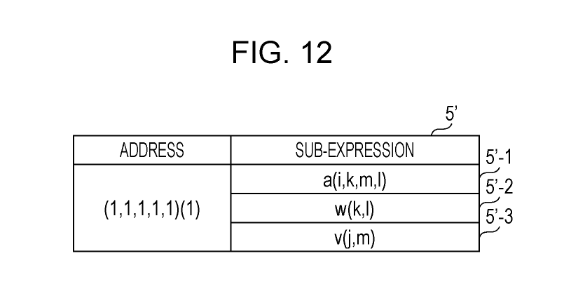

As illustrated in FIG. 12, the list 5′ stores a record 5′-1 in which the address (1,1,1,1,1) (1) corresponding to the contraction operation expression is associated with the sub-expression “a(i,k,m,l)”. The list 5′ stores a record 5′-2 in which an address (1,1,1,1,1) (1) corresponding to the contraction operation expression is associated with the sub-expression “w(k,l)”. The list 5′ stores a record 5′-3 in which an address (1,1,1,1,1) (1) corresponding to the contraction operation expression is associated with the sub-expression “v(j,m)”.

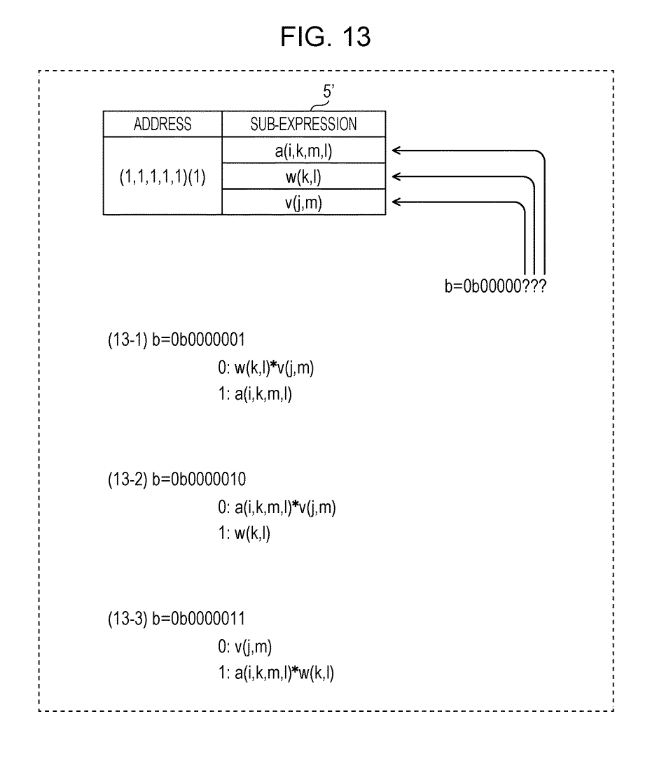

In FIG. 13, the information processing apparatus 100 generates a divided sub-expression by combining the divided sub-expressions obtained by dividing the sub-expression stored in the list 5 into two sub-expressions and the sub-expressions stored in the list 5′, adds the generated divided sub-expression to the list 6, and updates the list 6. In the following description, the divided sub-expressions obtained by dividing the sub-expression into two sub-expressions may be denoted as “divided sub-expression A and divided sub-expression B”.

<(13-1) In the Example of FIG. 13>

The information processing apparatus 100 prepares a variable b which indicates a pattern in which the sub-expressions are stored in the list 5′ and sets “1(0b00000001)” as the variable b. Inside of a parenthesis is denoted by an 8-bit binary number. Numbers of bits from an end of the variable b sequentially correspond to numbers of records from the top of the list 5′, respectively. For example, the first bit from the end of the variable b corresponds to the first record from the top of the list 5′.

The information processing apparatus 100 extracts the sub-expression “w(k,l)” and the sub-expression “v(j,m)” from a record corresponding to bit “0” of the variable b. The information processing apparatus 100 generates a sub-expression “w(k,l)*v(j,m)” obtained by connecting the extracted sub-expressions “w(k,l)” and “v(j,m)” by the target operator “*” as one divided sub-expression of the divided sub-expressions.

The information processing apparatus 100 extracts the sub-expression “a(i,k,m,l)” from a record corresponding to bit “1” of the variable b. The information processing apparatus 100 generates the extracted sub-expression “a(i,k,m,l)” as the other divided sub-expression “a(i,k,m,l)” of the divided sub-expressions. The information processing apparatus 100 adds a combination of one divided sub-expression and the other divided sub-expression generated to the list 6 and updates the list 6.

<(13-2) In the Example of FIG. 13>

The information processing apparatus 100 increments the variable b and sets “2(0b00000010)” as the variable b. The information processing apparatus 100 extracts the sub-expression “a(i,k,m,l)” and the sub-expression “v(j,m)” from a record corresponding to bit “0” of the variable b. The information processing apparatus 100 generates a sub-expression “a(i,k,m,l)*v(j,m)” obtained by connecting the extracted sub-expressions “a(i,k,m,l)” and “v(j,m)” by the target operator “*” as one divided sub-expression of the divided sub-expressions.

The information processing apparatus 100 extracts the sub-expression “w(k,l)” from a record corresponding to bit “1” of the variable b. The information processing apparatus 100 generates the extracted sub-expression “w(k,l)” as the other divided sub-expression “w(k,l)” of the divided sub-expressions. The information processing apparatus 100 adds a combination of one divided sub-expression and the other divided sub-expression generated to the list 6 and updates the list 6.

<(13-3) In the Example of FIG. 13>

The information processing apparatus 100 increments the variable b and sets “3(0b00000011)” as the variable b. The information processing apparatus 100 extracts the sub-expression “v(j,m)” from a record corresponding to bit “0” of the variable b. The information processing apparatus 100 generates the extracted sub-expression “v(j,m)” as one divided sub-expression of the divided sub-expressions.

Further, the information processing apparatus 100 extracts the sub-expression “a(i,k,m,l)” and the sub-expression “w(k,l)” from a record corresponding to bit “1” of the variable b. The information processing apparatus 100 generates a sub-expression “a(i,k,m,l)*w(k,l)” obtained by connecting the extracted sub-expressions “a(i,k,m,l)” and “w(k,l)” by the target operator “*” as the other divided sub-expression “a(i,k,m,l)” and “w(k,l)”. The information processing apparatus 100 adds a combination of one divided sub-expression and the other divided sub-expression generated to the list 6 and updates the list 6.

As illustrated in FIG. 14, the list 6 stores a record 6-1 in which the address (1,1,1,1,1) (1), a combination of the divided sub-expressions “a(i,k,m,l)*w(k,l)*v(j,m)” and “1”, and an ID of the combination “0” are associated with each other. The list 6 stores a record 6-2 in which the address (1,1,1,1,1) (1), a combination of the divided sub-expressions “w(k,l)*v(j,m)” and “a(i,k,m,l)”, and an ID of the combination “1” are associated with each other.

The list 6 stores a record 6-3 in which the address (1,1,1,1,1) (1), a combination of the divided sub-expressions “a(i,k,m,l)*v(j,m)” and “w(k,l)”, and an ID of the combination “2” are associated with each other. The list 6 stores a record 6-4 in which the address (1,1,1,1,1) (1), a combination of the divided sub-expressions “v(j,m)” and “a(i,k,m,l)*w(k,l)”, and an ID of the combination “3” are associated with each other.

<<Example of Classification of Scalar Variable>>

FIG. 15 is a diagram illustrating an example of classification of a scalar variable. In FIG. 15, the information processing apparatus 100 classifies a scalar variable used for an index in a contraction operation expression into a parameter and a contractible variable for each record of the list 6 to thereby store a classification result in a list 7.

For example, if the left side of the contraction operation expression is an array variable, the information processing apparatus 100 sets the scalar variable used for an index of the array variable of the left side as a parameter. The information processing apparatus 100 sets the scalar variable used in a loop statement in an initialization loop portion in which the scalar variable is initialized as a parameter.

The information processing apparatus 100 sets the scalar variable used for an index in common in both of the combinations of the divided sub-expressions of the record of the list 6 as a parameter. The information processing apparatus 100 sets a scalar variable, which is not set to a parameter of the scalar variables used for an index in the combination of the divided sub-expressions of the record of the list 6, to a contractible variable.

The information processing apparatus 100 sets scalar variables i and j as parameters regarding a record 6-1. The information processing apparatus 100 sets scalar variables k, l, and m as contractible variables regarding the record 6-1. The information processing apparatus 100 generates a record 7-1 in which stored contents, the parameter, and the contractible variable of the record 6-1 are associated with each other, adds the record 7-1 to the list 7, and updates the list 7.

The information processing apparatus 100 sets scalar variables i, j, and m as parameters regarding a record 6-2. The information processing apparatus 100 sets scalar variables k and l as contractible variables in a record 6-2. The information processing apparatus 100 generates a record 7-2 in which stored contents, the parameter, and the contractible variable of the record 6-2 are associated with each other, adds the record 7-2 to the list 7, and updates the list 7.

The information processing apparatus 100 sets scalar variables i, j, k, l, and m as parameters regarding a record 6-3. The information processing apparatus 100 does not set the contractible variable regarding the record 6-3. The information processing apparatus 100 generates a record 7-3 in which stored contents of the record 6-3 and the parameter are associated with each other, adds the record 7-3 to the list 7, and updates the list 7.

The information processing apparatus 100 sets scalar variables i, j, k, and l as parameters regarding a record 6-4. The information processing apparatus 100 sets scalar variables m as the contractible variable regarding the record 6-4. The information processing apparatus 100 generates a record 7-4 in which stored contents, the parameter, and the contractible variable of the record 6-4 are associated with each other, adds the record 7-4 to the list 7, and updates the list 7.

As illustrated in FIG. 15, for example, the list 7 stores a record 7-1 in which stored contents of the record 6-1 of the list 6, the parameters “i and j”, and the contractible variables “k, l, and m” are associated with each other. The list 7 stores a record 7-2 in which stored contents of the record 6-2 of the list 6, the parameters “i, j, and m”, and the contractible variables “k and l” are associated with each other.

The list 7 stores a record 7-3 in which stored contents of the record 6-3 of the list 6, the parameters “i, j, k, l, and m” and the contractible variable “none” are associated with each other. The list 7 stores the record 7-4 in which stored contents of the record 6-4 of the list 6, the parameters “i, j, k, and l”, and the contractible variable “m” are associated with each other.

<<Example of Calculation of Amount of Operation to be Decreased>>

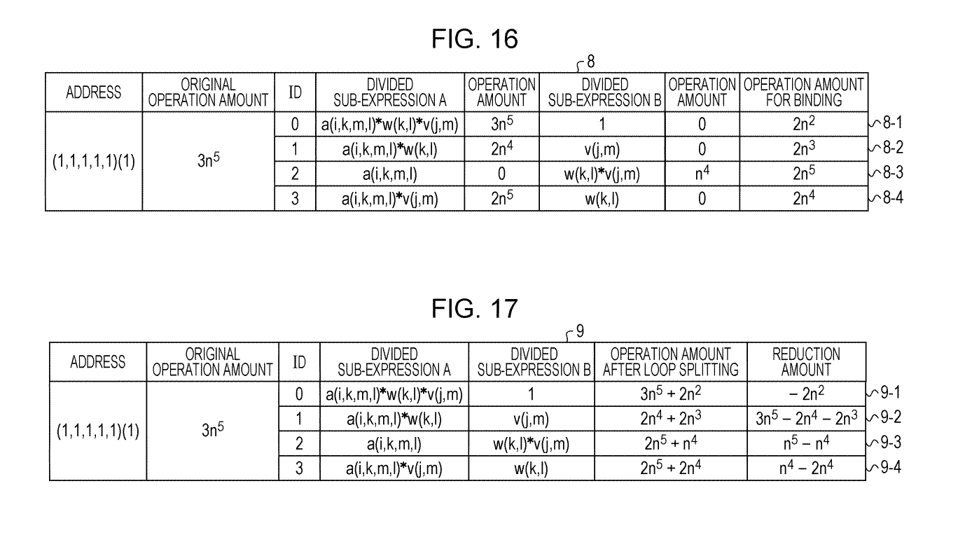

FIG. 16 and FIG. 17 are diagrams illustrating an example of calculation of an amount of operation to be decreased. In FIG. 16, the information processing apparatus 100 calculates an amount of operation to be decreased in the entire loop process in a case where the respective divided sub-expressions are computed separately and stores the amount of operation in a list 8. In the following description, the amount of operation to be decreased in the entire loop process may be denoted as a “reduction amount”.

The information processing apparatus 100, for example, calculates an amount of operation related to a case where an operation for the contraction operation expression is performed in the multi-loop portion. In the following description, the amount of operation related to a case where the operation is performed in the multi-loop portion may be denoted as an “original operation amount”.

The information processing apparatus 100 extracts the divided sub-expression from the contraction operation expression, and calculates the amount of operation related to a case where the operation of the extracted divided sub-expression and the operation of the contraction operation expression using the operation result of the extracted divided sub-expression are performed in separated loop portions, for each record of the list 7. In the following description, the amount of operation related to a case where the operations are performed in the separated loop portion may be denoted as an “operation amount after loop splitting”. Lastly, the information processing apparatus 100 calculates the difference obtained by subtracting the operation amount after loop division from the original operation amount as the reduction amount.

In FIG. 16, the information processing apparatus 100 extracts the divided sub-expression “a(i,k,m,l)*w(k,l)*v(j,m)” from the record 7-1 of the list 7 and sets the divided sub-expression as a target divided sub-expression. Since the contractible variable is included in the target divided sub-expression, the information processing apparatus 100 adds the operator “+” used for the contraction operation regarding the target divided sub-expression to the target operator and sets “1” as the number of operators “+”. The information processing apparatus 100 adds the operator “*” included in the target divided sub-expression to the target operator and sets “2” as the number of operators “*”.

The information processing apparatus 100 sets “1” as the total number of the number of repetition times. The information processing apparatus 100 specifies the scalar variables “i, j, k, l, m” used in in the target divided sub-expression of the scalar variables “i, j, k, l, m” used for the index in the contraction operation expression. The information processing apparatus 100 sets “n̂5” as the total number of the number of repetition times by multiplying the total number of the number of repetition times and the number of repetition times of each scalar variable of the scalar variables “i, j, k, l, m”.

The information processing apparatus 100 sets the “total number of the number of repetition times=n̂5” as a unit of operation. The information processing apparatus 100 sets a value “3n̂5” obtained by multiplying the number of each target operator with the unit of operation as the amount of operation regarding the target divided sub-expression of the amount of operation after loop splitting.

The information processing apparatus 100 extracts the divided sub-expression “1” from the record 7-1 of the list 7 and sets the divided sub-expression as a target divided sub-expression. Since the contractible variable is not included in the target divided sub-expression and an operator used for the contraction operation regarding the target divided sub-expression is not present, the number of target operators is not counted. Since an operator included in the target divided sub-expression is not present, the number of target operators is not counted.

The information processing apparatus 100 sets “1” as the total number of the number of repetition times. Since the scalar variable used for the target divided sub-expression is not present, the information processing apparatus 100 maintains “1” unchanged as the total number of the number of repetition times. The information processing apparatus 100 sets “the total number of the number of repetition times=1” as unit of operation. The information processing apparatus 100 sets a value “0” obtained by multiplying the number of each target operator with the unit of operation as the amount of operation regarding the target divided sub-expression of the operation amount after loop splitting.

The information processing apparatus 100 binds the combination of the divided sub-expressions of the record 7-1 of the list 7, specifies the operator used when implementing the contraction operation expression, and counts the number of operators for each type of the operator. Here, the information processing apparatus 100 sets “1” as the number of operators “*” which binds the combination of the divided sub-expressions. The information processing apparatus 100 sets “1” as the number of operators “+” used for the contraction operation regarding the target divided sub-expressions that are bound.

The information processing apparatus 100 sets “1” as a unit of binding. The information processing apparatus 100 specifies the parameters “i and j” of the record 7-1 of the list 7. The information processing apparatus 100 sets “n̂2” as a unit of binding by multiplying the unit of binding and the number of repetition times of each parameter of the parameters “i and j”.

The information processing apparatus 100 sets the value “2n̂2” obtained by multiplying the number of respective operators and the unit of binding as the amount of operation related to the binding of the combinations of divided sub-expressions and the contraction operation regarding the result obtained by the binding, of the operation amount after loop splitting. In the following description, the amount of operation related to the binding of the combinations of divided sub-expressions and the contraction operation regarding the result obtained by the binding may be collectively denoted by an “operation amount regarding binding”. The information processing apparatus 100 sets the “n̂5” as the original operation amount by multiplying the original operation amount and the number of repetition times of each of the scalar variables “i, j, k, l, and m”.

In FIG. 17, the information processing apparatus 100 calculates the difference obtained by subtracting the operation amount after loop splitting regarding the divided sub-expression of each record of the list 8 from the original operation amount. The operation amount after loop splitting is a total of the amount of operation regarding the target divided sub-expression and the amount of operation regarding the binding. Next, the information processing apparatus 100 stores the calculated difference in a list 9 as the reduction amount. The information processing apparatus 100 acquires a record having the largest reduction amount of the record of the list 9. Thereafter, the information processing apparatus 100 determines the combination of the divided sub-expressions stored in the acquired record as a sub-expression for optimizing a loop.

<<Example of Optimization of Source Code 400>>

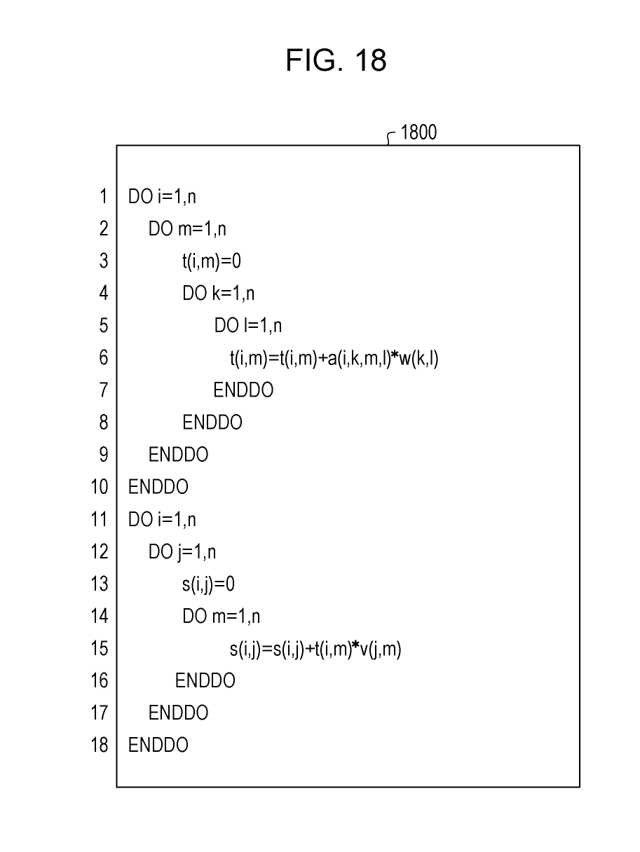

FIG. 18 is a diagram for explaining an example of optimization of the source code 400. The example of FIG. 18 is an example of a source code 1800 obtained by optimizing the source code 400.

In the example of FIG. 18, a loop statement “DO i=1, n (loop body) ENDDO” is described in the first row and the tenth row of the source code 1800. The loop body which is repeatedly executed by the loop statement “DO i=1, n (loop body) ENDDO” is described in a portion from the second row to the ninth row of the source code 1800. With this, contents of the loop process, which repeatedly executes the processing within the loop body until the variable i reaches n, where the variable i begins from 1, are described in a portion from the first row to the tenth row of the source code 1800.

A loop statement “DO m=1, n (loop body) ENDDO” is described in the second row and the ninth row of the source code 1800. The loop body which is repeatedly executed by the loop statement “DO m=1, n (loop body) ENDDO” is described in a portion from the third row to the eighth row of the source code 1800. With this, contents of the loop process, which repeatedly executes the processing within the loop body until the variable m reaches n, where the variable m begins from 1, are described in a portion from the second row to the ninth row of the source code 1800.

An assignment statement “t(i,m)=0” is described in the third row of the source code 1800. With this, contents of initialization processing for assigning a numerical value “0” to a value of an array variable t(i,m) are described in the third row of the source code 1800.

A loop statement “DO k=1, n (loop body) ENDDO” is described in the fourth row and the eighth row of the source code 1800. The loop body which is repeatedly executed by the loop statement “DO k=1, n (loop body) ENDDO” is described in a portion from the fifth row to the seventh row of the source code 1800. With this, contents of the loop process, which repeatedly executes the processing within the loop body until the variable k reaches n, where the variable k begins from 1, are described in a portion from the fourth row to the eighth row of the source code 1800.

A loop statement “DO l=1, n (loop body) ENDDO” is described in the fifth row and the seventh row of the source code 1800. The loop body which is repeatedly executed by the loop statement “DO l=1, n (loop body) ENDDO” is described in the sixth row of the source code 1800. With this, contents of the loop process, which repeatedly executes the processing within the loop body until the variable l reaches n, where the variable l begins from 1, are described in a portion from the fifth row to the seventh row of the source code 1800.

An assignment statement “t(i,m)=t(i,m)+a(i,k,m,l)*w(k,l)” is described in the sixth row of the source code 1800. With this, contents of assignment processing for assigning a value of an array variable t(i,m)+an array variable a(i,k,m,j)*an array variable w(k,l) to the value of an array variable t(i,m) are described in the sixth row of the source code 1800.

In this manner, a portion from the first row to the tenth row of the source code 1800 is a multi-loop portion in which a collection of a plurality of loop statements having a nest structure is described. The portion from the first to the third rows, the ninth row and the tenth row of the source code 1800 is an initialization loop portion in which a collection of a plurality of loop statements having a nest structure is described and which changes the variables i and m, switches an array variable t(i,m) on which the contraction operation is performed, and initializes the switched array variable t(i,m). The fourth row to the eighth row of the source code 1800 is a contraction operation loop portion in which a collection of a plurality of loop statements having a nest structure is described and which performs the contraction operation with respect to the initialized array variable t(i,m) by repeating an assignment operation with respect to the initialized array variable t(i,m).

A loop statement “DO i=1, n (loop body) ENDDO” is described in the eleventh row and the eighteenth row of the source code 1800. The loop body which is repeatedly executed by the loop statement “DO i=1, n (loop body) ENDDO” is described in a portion from the twelfth row to the seventeenth row of the source code 1800. With this, contents of the loop process, which repeatedly executes the processing within the loop body until the variable i reaches n, where the variable i begins from 1, are described in a portion from the eleventh row to the eighteenth row of the source code 1800.

A loop statement “DO j=1, n (loop body) ENDDO” is described in the twelfth row and the seventeenth row of the source code 1800. The loop body which is repeatedly executed by the loop statement “DO j=1, n (loop body) ENDDO” is described in a portion from the thirteenth row to the sixteenth row of the source code 1800. With this, contents of the loop process, which repeatedly executes the processing within the loop body until the variable j reaches n, where the variable j begins from 1, are described in a portion from the twelfth row to the seventeenth row of the source code 1800.

An assignment statement “s(i,j)=0” is described in the thirteenth row of the source code 1800. With this, contents of initialization processing for assigning a numerical value “0” to an array variable s(i,j) are described in the thirteenth row of the source code 1800.

A loop statement “DO m=1, n (loop body) ENDDO” is described in the fourteenth row and the sixteenth row of the source code 1800. The loop body which is repeatedly executed by the loop statement “DO m=1, n (loop body) ENDDO” is described in the fifteenth row of the source code 1800. With this, contents of the loop process, which repeatedly executes the processing within the loop body until the variable m reaches n, where the variable m begins from 1, are described in a portion from the fourteenth row to the sixteenth row of the source code 1800.

An assignment statement “s(i,j)=s(i,j)+t(i,m)*v(j,m)” is described in the fifteenth row of the source code 1800. With this, contents of assignment processing for assigning a value of an array variable s(i,j)+an array variable t(i,m)*an array variable v(j,m) to a value of an array variable s(i,j) are described in the fifteenth row of the source code 1800.

In this manner, a portion from the eleventh row to the eighteenth row of the source code 1800 is a multi-loop portion in which a collection of a plurality of loop statements having a nest structure is described. The portion from the eleventh to the thirteenth rows, the seventeenth row and the eighteenth row of the source code 1800 is an initialization loop portion in which a collection of a plurality of loop statements having a nest structure is described and which changes the variables i and j, switches an array variable s(i,j) on which the contraction operation is performed, and initializes the switched array variable s(i,j). The fourteenth row to the sixteenth row of the source code 1800 is a contraction operation loop portion in which a collection of a plurality of loop statements having a nest structure is described and which performs the contraction operation with respect to the initialized array variable s(i,j) by repeating an assignment operation with respect to the initialized array variable s(i,j).

<<Example of Procedural Sequence of Compile Process>>

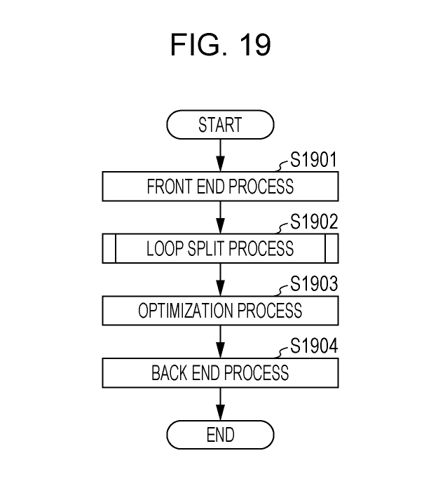

Next, an example of a procedural sequence of a compile process is described using FIG. 19.

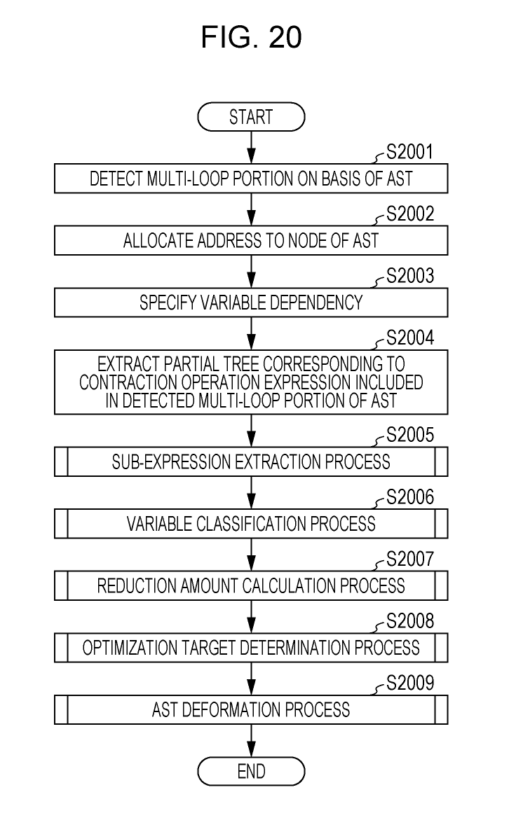

FIG. 19 is a flowchart illustrating an example of a procedural sequence of a compile process. In FIG. 19, the information processing apparatus 100 acquires a source code and executes a front-end process to generate the AST, the variable table, and the function table (Step S1901). Next, the information processing apparatus 100 executes a loop split process which is described later with reference to FIG. 20 (Step S1902). The information processing apparatus 100 executes an optimization process (Step S1903).

Next, the information processing apparatus 100 executes a back end process for generating an object code, based on the AST, the variable table, and the like after optimization (Step S1904). The information processing apparatus 100 ends a compile process. With this, the information processing apparatus 100 may generate an object code which is optimized by reducing an amount of operation at the time of software execution.

<<Example of Procedural Sequence of Loop Split Process>>

Next, description is made on an example of a procedural sequence of a loop split process indicated in S1902 of FIG. 19 using FIG. 20.

FIG. 20 is a flowchart illustrating an example of a procedural sequence of a loop split process. In FIG. 20, the information processing apparatus 100 detects the multi-loop portion, based on the AST (Step S2001). Next, the information processing apparatus 100 allocates an address to a node of the AST (Step S2002). The information processing apparatus 100 specifies variable dependency (Step S2003).

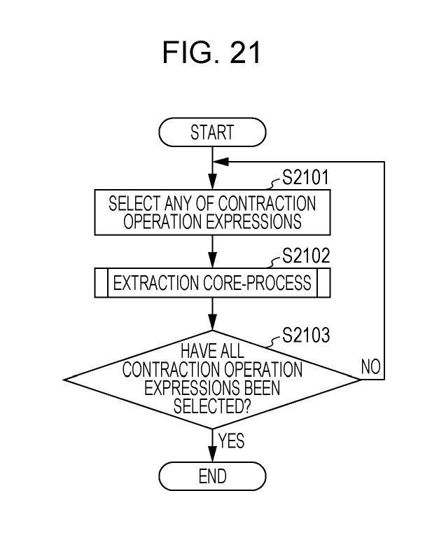

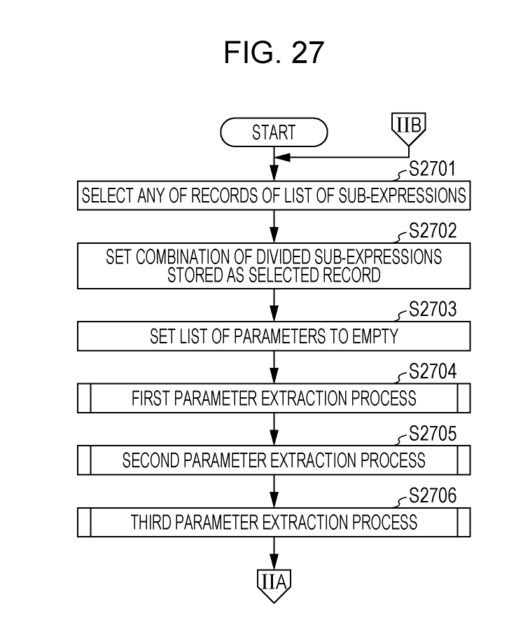

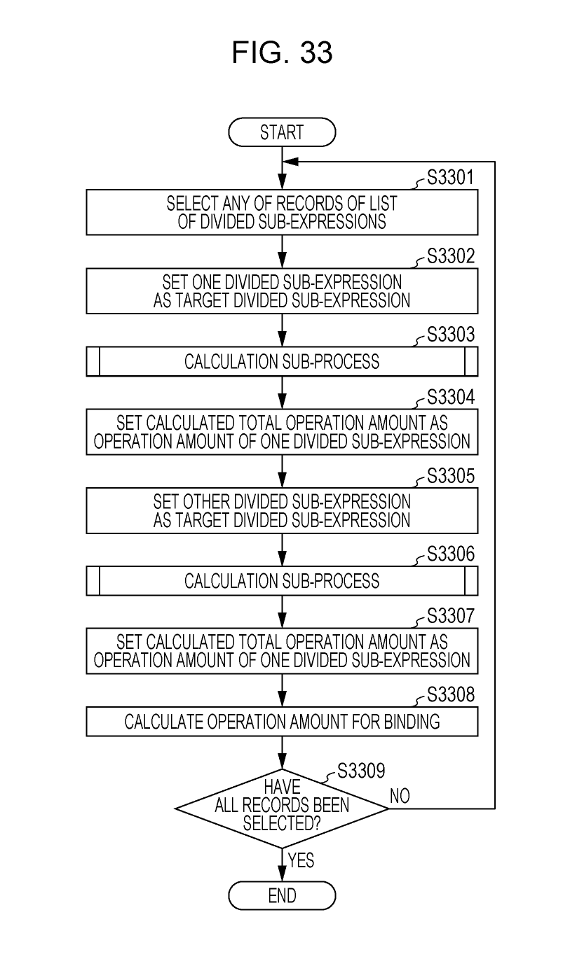

Next, the information processing apparatus 100 extracts a partial tree corresponding to a contraction operation expression included in the detected multi-loop portion of the AST (Step S2004). The information processing apparatus 100 executes a sub-expression extraction process which is described later with reference to FIG. 21 (Step S2005). The information processing apparatus 100 executes a variable classification process which is described later with reference to FIG. 27 (Step S2006). The information processing apparatus 100 executes a reduction amount calculation process which is described later with reference to FIG. 33 (Step S2007).

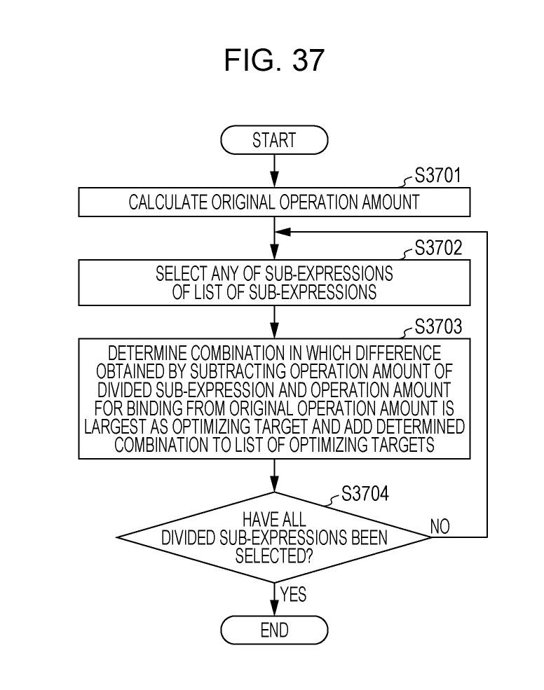

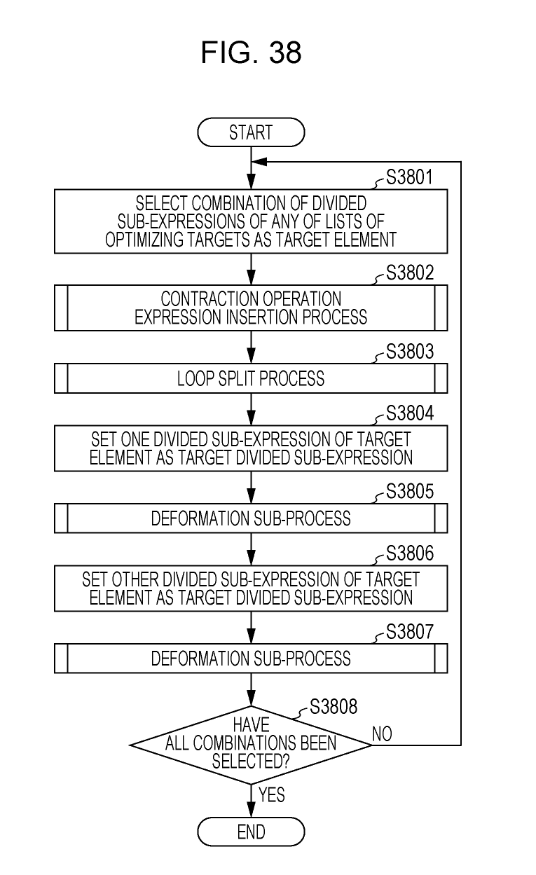

Next, the information processing apparatus 100 executes an optimization target determination process which is described later with reference to FIG. 37 (Step S2008). The information processing apparatus 100 executes an AST deformation process which is described later with reference to FIG. 38 (Step S2009). Next, the information processing apparatus 100 ends the procedural sequence of the loop split process. With this, the information processing apparatus 100 may perform optimization by reducing an amount of operation of software during software execution.

<<Example of Procedural Sequence of Sub-Expression Extraction Process>>

Next, description is made on an example of a procedural sequence of a sub-expression extraction process indicated in Step S2005 of FIG. 20 using FIG. 21.

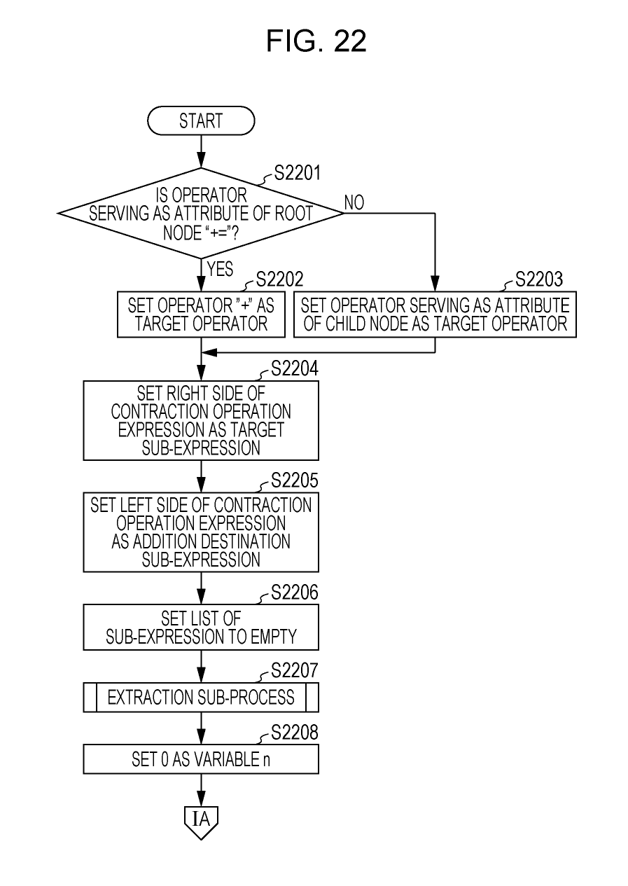

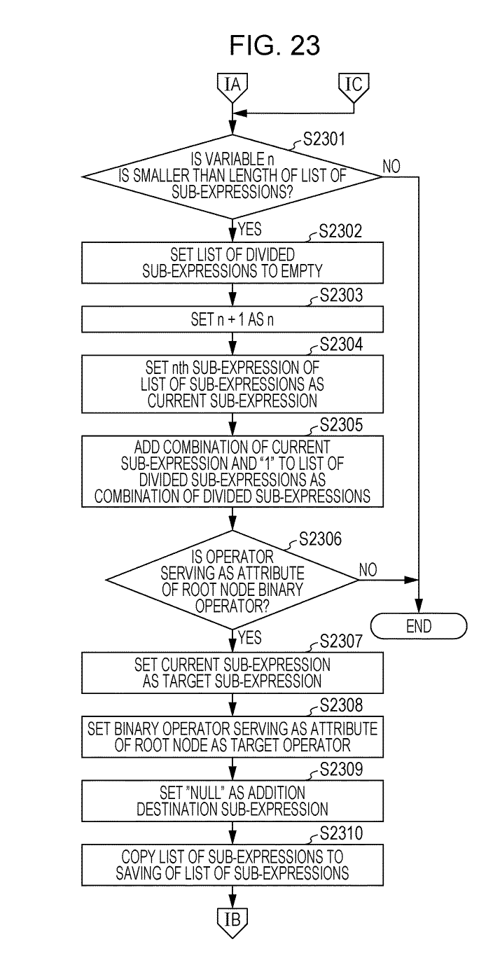

FIG. 21 is a flowchart illustrating an example of a procedural sequence of a sub-expression extraction process. In FIG. 21, the information processing apparatus 100 selects any of contraction operation expressions (Step S2101). The information processing apparatus 100 executes an extraction core-process, which is described later with reference to FIG. 22 and FIG. 23, with respect to the selected contraction operation expression (Step S2102).

The information processing apparatus 100 determines whether all contraction operation expressions have been selected (Step S2103). Here, in a case where an unselected contraction operation expression is present (Step S2103: No), the information processing apparatus 100 returns to Step S2101.

In the meantime, in a case where all of contraction operation expressions have been selected (Step S2103: Yes), the information processing apparatus 100 ends the sub-expression extraction process. With this, the information processing apparatus 100 may extract a sub-expression within the contraction operation expression serving as a candidate of a sub-expression used when reducing the amount of operation during software execution.

<<Example of Procedural Sequence of Extraction Core-Process>>

Next, description is made on an example of a procedural sequence of an extraction core-process using FIG. 22 to FIG. 24.

FIG. 22 to FIG. 24 are flowcharts illustrating an example of a procedural sequence of an extraction core-process. In FIG. 22, the information processing apparatus 100 refers to a root node of a partial tree corresponding to a contraction operation expression and determines whether an operator serving as an attribute of the root node is “+=” (Step S2201).

In a case where the operator is “+=” (Step S2201: Yes), the information processing apparatus 100 sets the operator “+” as a target operator (Step S2202), and proceeds to the processing of Step S2204.

In a case where the operator is “=” (Step S2201: No), the information processing apparatus 100 refers to a child node corresponding to the right side of the contraction operation and sets an operator serving as an attribute of the child node as a target operator (Step S2203). The information processing apparatus 100 proceeds to the processing of Step S2204.

In Step S2204, the information processing apparatus 100 sets the right side of the contraction operation expression as the target sub-expression (Step S2204). Next, the information processing apparatus 100 sets the left side of the contraction operation expression as an addition destination sub-expression (Step S2205). The information processing apparatus 100 sets a list of sub-expressions to empty (Step S2206).

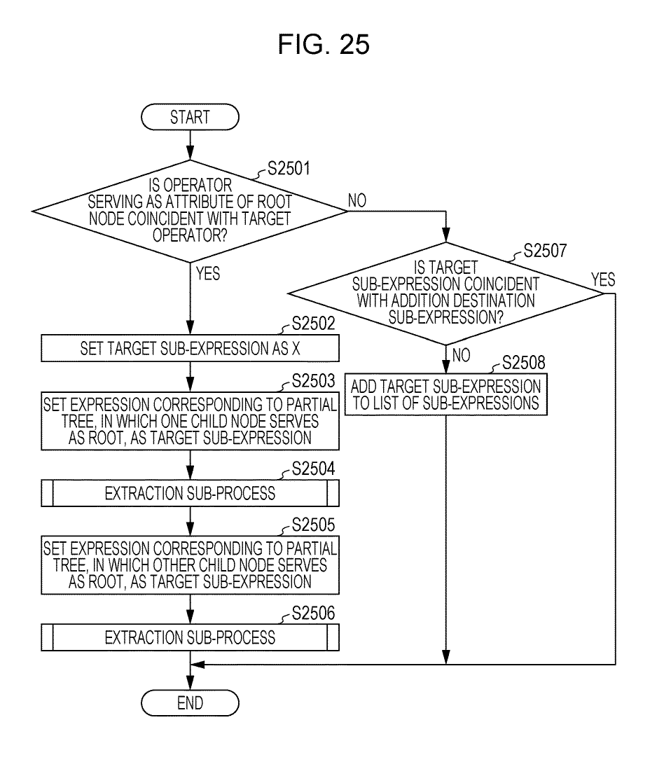

Next, the information processing apparatus 100 executes an extraction sub-process which is described later with reference to FIG. 25 (Step S2207). The information processing apparatus 100 sets 0 as variable n (Step S2208). Thereafter, the information processing apparatus 100 proceeds to the processing of Step S2301 of FIG. 23.

In FIG. 23, the information processing apparatus 100 determines whether the variable n is smaller than a length of the list of sub-expressions (Step S2301). In a case where the variable n is equal to or greater than the length of the list of sub-expressions (Step S2301: No), the information processing apparatus 100 ends the extraction core-process.

In a case where the variable n is smaller than the length of the list of sub-expressions (Step S2301: Yes), the information processing apparatus 100 sets a list of divided sub-expressions to empty (Step S2302). Next, the information processing apparatus 100 sets n+1 as n (Step S2303). The information processing apparatus 100 sets an nth sub-expression of the list of sub-expressions as the current sub-expression (Step S2304).

Next, the information processing apparatus 100 adds a combination of current sub-expression and “1” to the list of divided sub-expressions as a combination of divided sub-expressions (Step S2305). The information processing apparatus 100 refers to the root node of the partial tree corresponding to the current sub-expression and determines whether an operator serving as an attribute of root the node is a binary operator (Step S2306). In a case where the operator is not a binary operator (Step S2306: No), the information processing apparatus 100 ends the extraction core-process.

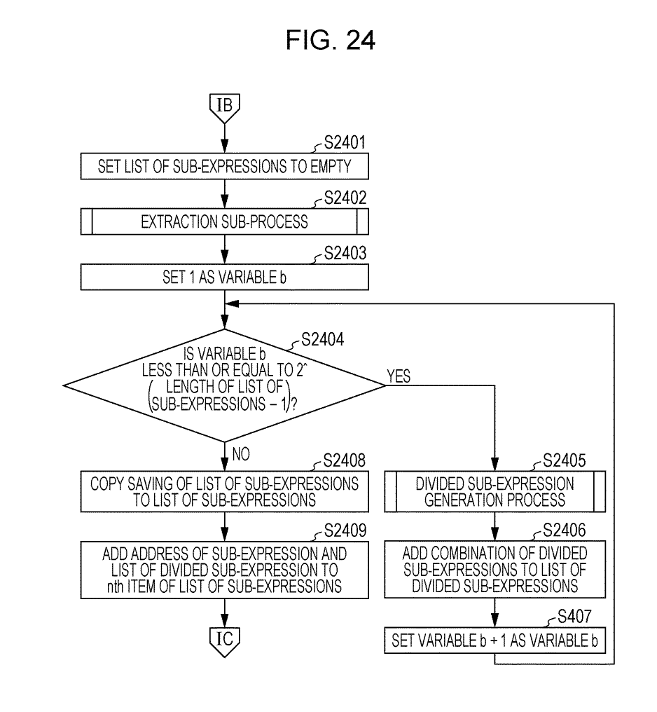

In a case where the operator is a binary operator (Step S2306: Yes), the information processing apparatus 100 sets the current sub-expression as a target sub-expression (Step S2307). Next, the information processing apparatus 100 sets the binary operator serving as an attribute of a parent node as the target operator (Step S2308). The information processing apparatus 100 sets “NULL” as an addition destination sub-expression (Step S2309). The information processing apparatus 100 copies the list of sub-expressions to save the list of sub-expressions (Step S2310). The information processing apparatus 100 proceeds to the processing of Step S2401 of FIG. 24.

In FIG. 24, the information processing apparatus 100 sets the list of sub-expressions to empty (Step S2401). Next, the information processing apparatus 100 executes an extraction sub-process which is described later with reference to FIG. 25 (Step S2402). The information processing apparatus 100 sets 1 as variable b (Step S2403).

The information processing apparatus 100 determines whether the variable b is less than or equal to 2̂ (length of list of sub-expressions−1) (Step S2404). In a case where the variable b is greater than 2̂ (length of list of sub-expressions−1) (Step S2404: No), the information processing apparatus 100 proceeds to the processing of Step S2408.

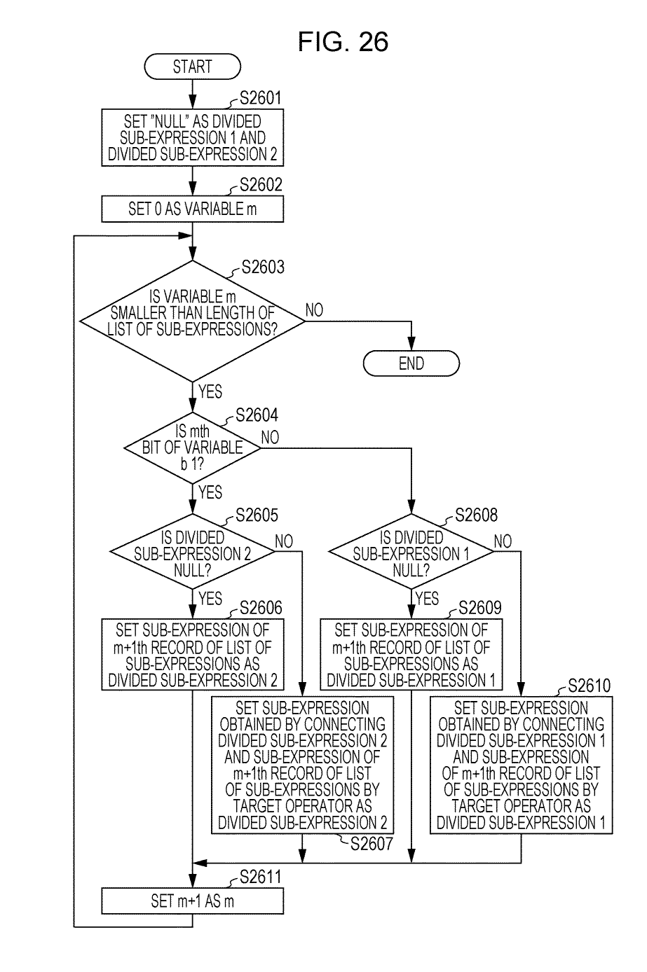

In a case where the variable b is less than or equal to 2̂ (length of list of sub-expressions−1) (Step S2404: Yes), the information processing apparatus 100 executes a divided sub-expression generation process which is described later with reference to FIG. 26 (Step S2405). The information processing apparatus 100 adds a combination of sub-expressions to the list of sub-expressions (Step S2406). The information processing apparatus 100 sets the variable b+1 as a variable b (Step S2407), and returns to processing of Step S2404.

In Step S2408, the information processing apparatus 100 copies the saved list of sub-expressions to the list of sub-expressions (Step S2408). Next, the information processing apparatus 100 adds an address of the sub-expression and the list of divided sub-expressions to an nth item of the list of sub-expressions (Step S2409). The information processing apparatus 100 returns to processing of Step S2301 of FIG. 23. With this, the information processing apparatus 100 may extract the sub-expression within the contraction operation expression.

<<Example of Procedural Sequence of Extraction Sub-Process>>

Next, description is made on an example of a procedural sequence of an extraction sub-process indicated in Step S2207 of FIG. 22 and Step S2402 of FIG. 24 using FIG. 25.

FIG. 25 is a flowchart illustrating an example of a procedural sequence of an extraction sub-process. In FIG. 25, the information processing apparatus 100 refers to the root node of the partial tree corresponding to the target sub-expression and determines whether the operator serving as the attribute of the root node coincides with the target operator (Step S2501). In a case where the operator coincides with the target operator (Step S2501: Yes), the information processing apparatus 100 sets the target sub-expression as X (Step S2502).

Next, the information processing apparatus 100 selects one child node of any of the partial trees corresponding to the X and sets the expression corresponding to the partial tree, in which the selected child node serves as the root, as the target sub-expression (Step S2503). The information processing apparatus 100 executes the extraction sub-process with respect to the target sub-expression (Step S2504).

Next, the information processing apparatus 100 selects the other child node of any of the partial trees corresponding to the X and sets the expression corresponding to the partial tree, in which the selected child node serves as the root, as the target sub-expression (Step S2505). The information processing apparatus 100 executes the extraction sub-process with respect to the target sub-expression (Step S2506). Thereafter, the information processing apparatus 100 ends the extraction sub-process.

In a case where the operator does not coincide with the target operator (Step S2501: No), the information processing apparatus 100 determines whether the target sub-expression coincides with the addition destination sub-expression (Step S2507). In a case where the target sub-expression does not coincide with the addition destination sub-expression (Step S2507: No), the information processing apparatus 100 adds the target sub-expression to the list of sub-expressions (Step S2508). The information processing apparatus 100 ends the extraction sub-process.

In the meantime, in a case where the target sub-expression coincides with the addition destination sub-expression (Step S2507: Yes), the information processing apparatus 100 ends the extraction sub-process. With this, the information processing apparatus 100 may extract the sub-expression within the contraction operation expression.

<<Example of Procedural Sequence of Divided Sub-Expression Generation Process>>

Next, description is made on an example of a procedural sequence of a divided sub-expression generation process using FIG. 26.

FIG. 26 is a flowchart illustrating an example of a procedural sequence of a divided sub-expression generation process. In FIG. 26, the information processing apparatus 100 sets “NULL” as divided sub-expression 1 and divided sub-expression 2 (Step S2601).

Next, the information processing apparatus 100 sets 0 as variable m (Step S2602). The information processing apparatus 100 determines whether the variable m is smaller than the length of the list of sub-expressions (Step S2603). In a case where the variable m is greater than the length (Step S2603: No), the information processing apparatus 100 ends the divided sub-expression generation process.

In a case where the variable m is smaller than the length (Step S2603: Yes), the information processing apparatus 100 determines whether an m-th bit of the variable b is 1 (Step S2604). In a case where the m-th bit is 0 (Step S2604: No), the information processing apparatus 100 proceeds to the processing of Step S2608.

In a case where the m-th bit is 1 (Step S2604: Yes), the information processing apparatus 100 determines whether the divided sub-expression 2 is NULL (Step S2605). In a case where the divided sub-expression 2 is NULL (Step S2605: Yes), the information processing apparatus 100 sets a sub-expression of an m+1th record of the list of sub-expressions as the divided sub-expression 2 (Step S2606), and proceeds to the processing of Step S2611.

In a case where the divided sub-expression 2 is not NULL (Step S2605: No), the information processing apparatus 100 sets a sub-expression obtained by connecting the divided sub-expression 2 and the sub-expression of the m+1th record of the list of sub-expressions by the target operator as the divided sub-expression 2 (Step S2607). The information processing apparatus 100 proceeds to the processing of Step S2611.

In Step S2608, the information processing apparatus 100 determines whether the divided sub-expression 1 is NULL (Step S2608). In a case where the divided sub-expression 1 is NULL (Step S2608: Yes), the information processing apparatus 100 sets the sub-expression of the m+1th record of the list of sub-expressions as the divided sub-expression 1 (Step S2609), and proceeds to the processing of Step S2611.

In a case where the divided sub-expression 1 is not NULL (Step S2608: No), the information processing apparatus 100 sets the sub-expression obtained by connecting the divided sub-expression 1 and the sub-expression of the m+1th record of the list of sub-expressions by the target operator as the divided sub-expression 1 (Step S2610). The information processing apparatus 100 proceeds to the processing of Step S2611.

In Step S2611, the information processing apparatus 100 sets m+1 as m (Step S2611), and returns to Step S2603. With this, the information processing apparatus 100 may generate a divided sub-expression which becomes a candidate of a sub-expression which is obtained by further dividing the sub-expression within the contraction operation expression and used when reducing the amount of operation during software execution.

<<Example of Procedural Sequence of Variable Classification Process>>

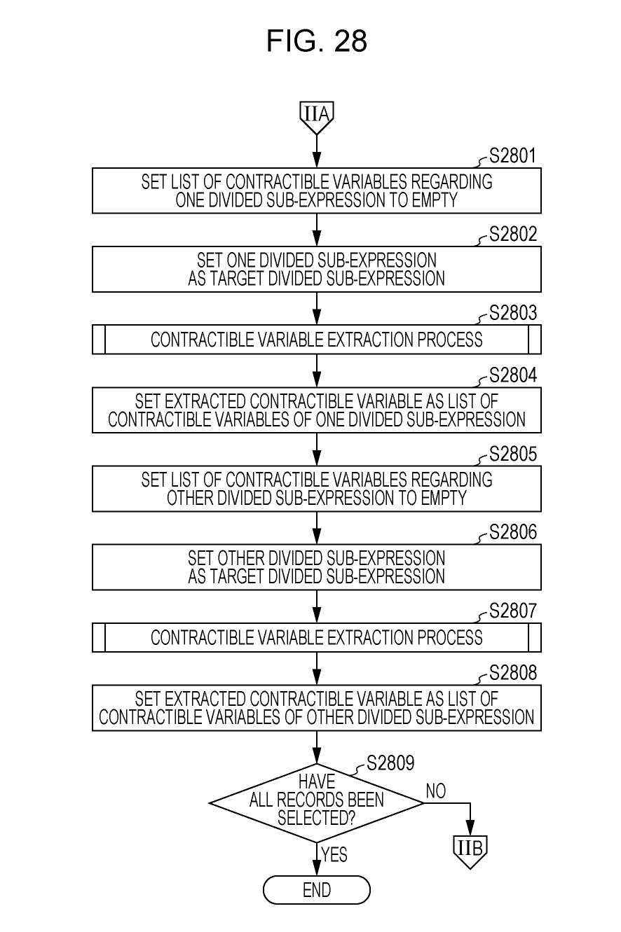

Description is made on an example of a procedural sequence of a variable classification process indicated in Step S2006 of FIG. 20 using FIG. 27 and FIG. 28.

FIG. 27 and FIG. 28 are flowcharts illustrating an example of a procedural sequence of a variable classification process. In FIG. 27, the information processing apparatus 100 selects any of the records of the list of sub-expressions (Step S2701). Next, the information processing apparatus 100 sets the combination of the divided sub-expressions stored in the selected record as the target divided sub-expression (Step S2702). The information processing apparatus 100 set a list of parameters to empty (Step S2703).

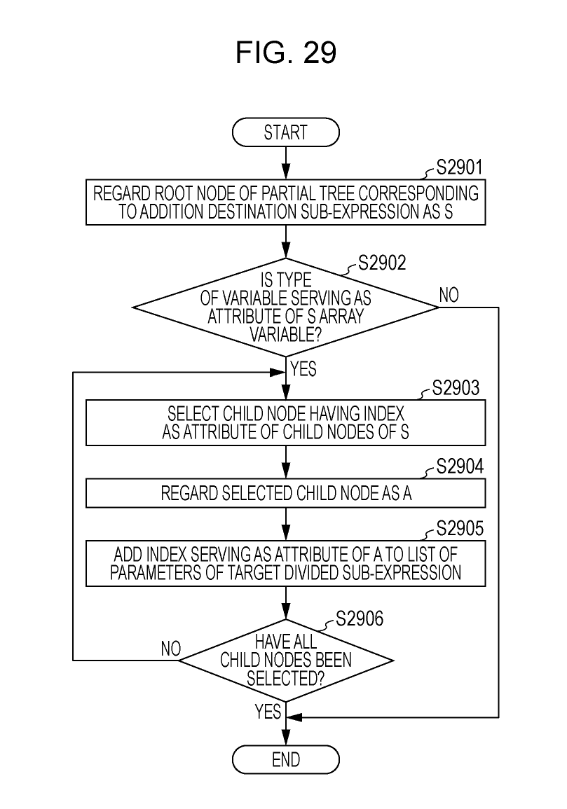

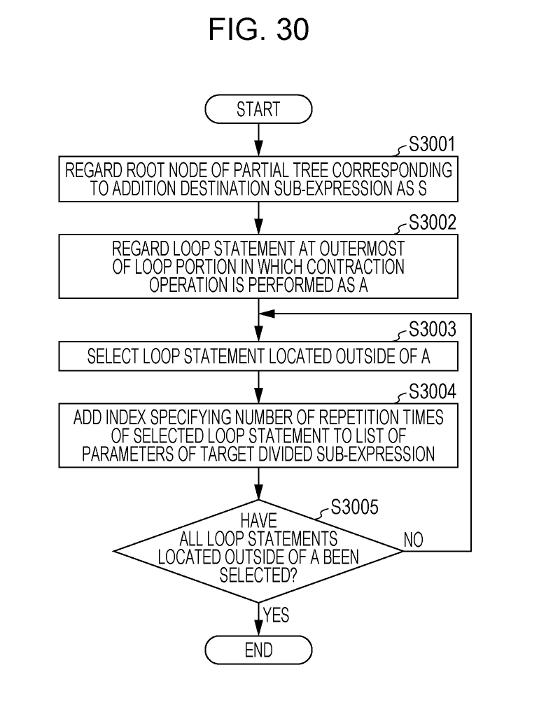

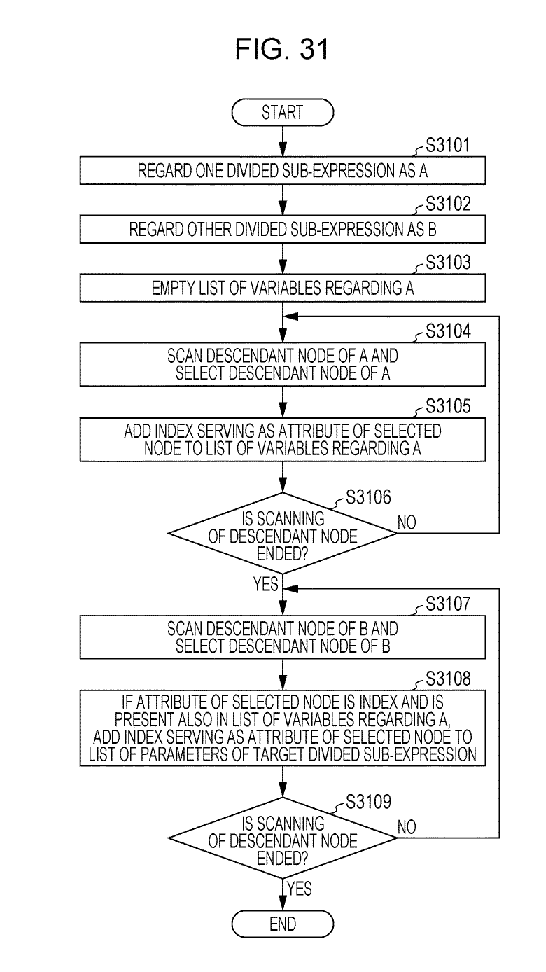

Next, the information processing apparatus 100 executes a first parameter extraction process which is described later with reference to FIG. 29 (Step S2704). The information processing apparatus 100 executes a second parameter extraction process which is described later with reference to FIG. 30 (Step S2705). The information processing apparatus 100 executes a third parameter extraction process which is described later with reference to FIG. 31 (Step S2706). The information processing apparatus 100 proceeds to the processing of Step S2801 of FIG. 28.

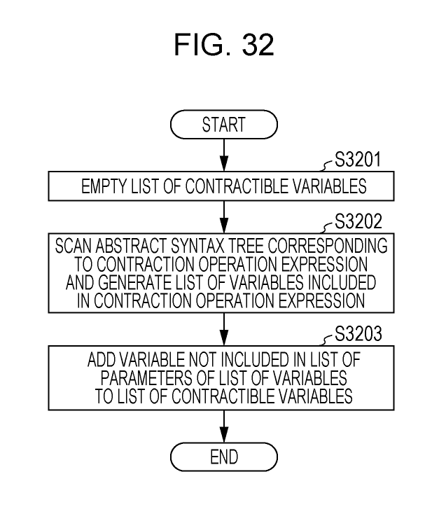

In FIG. 28, the information processing apparatus 100 sets the list of contractible variables for one divided sub-expression stored in the selected record to empty (Step S2801). Next, the information processing apparatus 100 sets one divided sub-expression stored in the selected record as the target divided sub-expression (Step S2802). The information processing apparatus 100 executes a contractible variable extraction process which is described later with reference to FIG. 32 (Step S2803). Thereafter, the information processing apparatus 100 sets the extracted contractible variable as the list of contractible variables of one divided sub-expression (Step S2804).

The information processing apparatus 100 sets the list of contractible variables in the other divided sub-expression stored in the selected record to empty (Step S2805). The information processing apparatus 100 sets the other divided sub-expression stored in the selected record as the target divided sub-expression (Step S2806). The information processing apparatus 100 executes the contractible variable extraction process which is described later with reference to FIG. 32 (Step S2807). Thereafter, the information processing apparatus 100 sets the extracted contractible variable as the list of contractible variables of the other divided sub-expression (Step S2808).

The information processing apparatus 100 determines whether all records have been selected (Step S2809). In a case where an unselected record is present (Step S2809: No), the information processing apparatus 100 returns to Step S2701 of FIG. 27.

In a case where all records have been selected (Step S2809: Yes), the information processing apparatus 100 ends the variable classification process. With this, the information processing apparatus 100 may obtain a result obtained by classifying the parameter and the contractible variable used at the time of calculation of the amount of operation decreased and deformation of the AST.

<<Example of Procedural Sequence of First Parameter Extraction Process>>

Next, description is made on an example of a procedural sequence of a first parameter extraction process indicated in Step S2704 of FIG. 27 using FIG. 29.

FIG. 29 is a flowchart illustrating an example of a procedural sequence of a first parameter extraction process. In FIG. 29, the information processing apparatus 100 regards the root node of the partial tree corresponding to the addition destination sub-expression of the contraction operation expression in which the target divided sub-expression is included as S (Step S2901).

The information processing apparatus 100 determines whether a type of the variable serving as an attribute of S is an array variable (Step S2902). In a case where the type is a scalar variable (Step S2902: No), the information processing apparatus 100 ends the first parameter extraction process.

In a case where the type is the array variable (Step S2902: Yes), the information processing apparatus 100 selects a child node having the index as an attribute of child nodes of S (Step S2903). Next, the information processing apparatus 100 regards the selected child node as A (Step S2904). The information processing apparatus 100 adds the index serving as the attribute of A to the list of parameters of the target divided sub-expression (Step S2905).

Next, the information processing apparatus 100 determines whether all child nodes having the index as an attribute have been selected (Step S2906). In a case where an unselected child node is present (Step S2906: No), the information processing apparatus 100 returns to the processing of Step S2903.

In a case where all child nodes have been selected (Step S2906: yes), the information processing apparatus 100 ends the first parameter extraction process. With this, the information processing apparatus 100 may extract the parameter.

<<Example of Procedural Sequence of Second Parameter Extraction Process>>

Next, description is made on an example of a procedural sequence of a second parameter extraction process indicated in Step S2705 of FIG. 27 using FIG. 30.

FIG. 30 is a flowchart illustrating an example of a procedural sequence of a second parameter extraction process. In FIG. 30, the information processing apparatus 100 regards the root node of the partial tree corresponding to the addition destination sub-expression of the contraction operation expression in which the target divided sub-expression is included as S (Step S3001).

Next, the information processing apparatus 100 regards a loop statement at the outermost portion of a loop portion in which the contraction operation is performed as A (Step S3002). The information processing apparatus 100 selects the loop statement located outside of A (Step S3003).

The information processing apparatus 100 adds an index specifying the number of repetition times of the selected loop statement to the list of parameters of the target divided sub-expression (Step S3004). The information processing apparatus 100 determines whether all loop statements located outside of A have been selected (Step S3005). In a case where an unselected loop statement is present (Step S3005: No), the information processing apparatus 100 returns to the processing of Step S3003.

In a case where all loop statements have been selected (Step S3005: yes), the information processing apparatus 100 ends the second parameter extraction process. With this, the information processing apparatus 100 may extract the parameter.

<<Example of Procedural Sequence of Third Parameter Extraction Process>>

Next, description is made on an example of a procedural sequence of a third parameter extraction process indicated in Step S2706 of FIG. 27 using FIG. 31.

FIG. 31 is a flowchart illustrating an example of a procedural sequence of a third parameter extraction process. In FIG. 31, the information processing apparatus 100 regards one divided sub-expression of the target divided sub-expression as A (Step S3101). Next, the information processing apparatus 100 regards the other divided sub-expression of the target divided sub-expression as B (Step S3102). The information processing apparatus 100 empties the list of variables for A (Step S3103).

The information processing apparatus 100 scans a descendant node of A and selects the descendant node of A (Step S3104). If an attribute of the selected node is an index, the information processing apparatus 100 adds the index serving as the attribute of the selected node to the list of variables regarding A (Step S3105).

Thereafter, the information processing apparatus 100 determines whether scanning of the descendant node is ended (Step S3106). In a case where the scanning is not ended (Step S3106: No), the information processing apparatus 100 returns to the processing of Step S3104.

In a case where the scanning is ended (Step S3106: Yes), the information processing apparatus 100 scans a descendant node of B and selects the descendant node of B (Step S3107). If the attribute of the selected node is the index and is present also in the list of the variables regarding A, the information processing apparatus 100 adds the index serving as the attribute of the selected node to the list of parameters of the target divided sub-expression (Step S3108).

Thereafter, the information processing apparatus 100 determines whether the scanning of the descendant node is ended (Step S3109). In a case where the scanning is not ended (Step S3109: No), the information processing apparatus 100 returns to the processing of Step S3107.

In a case where the scanning is ended (Step S3109: Yes), the information processing apparatus 100 ends the third parameter extraction process. With this, the information processing apparatus 100 may extract the parameter.

<<Example of Procedural Sequence of Contractible Variable Extraction Process>>

Next, description is made on an example of a procedural sequence of a contractible variable extraction process indicated in Step S2803 of FIG. 28 using FIG. 32.

FIG. 32 is a flowchart illustrating an example of a procedural sequence of a contractible variable extraction process. In FIG. 32, the information processing apparatus 100 empties the list of the contractible variables (Step S3201). Next, the information processing apparatus 100 scans an abstract syntax tree corresponding to the contraction operation expression and generates a list of variables included in the contraction operation expression (Step S3202).

The information processing apparatus 100 adds the variable not included in the list of parameters of the list of variables to the list of contractible variables (Step S3203). Thereafter, the information processing apparatus 100 ends the contractible variable extraction process. With this, the information processing apparatus 100 may extract the contractible variable.

<<Example of Procedural Sequence of Reduction Amount Calculation Process>>

Next, description is made on an example of a procedural sequence of a reduction amount calculation process indicated in Step S2007 of FIG. 20 using FIG. 33.

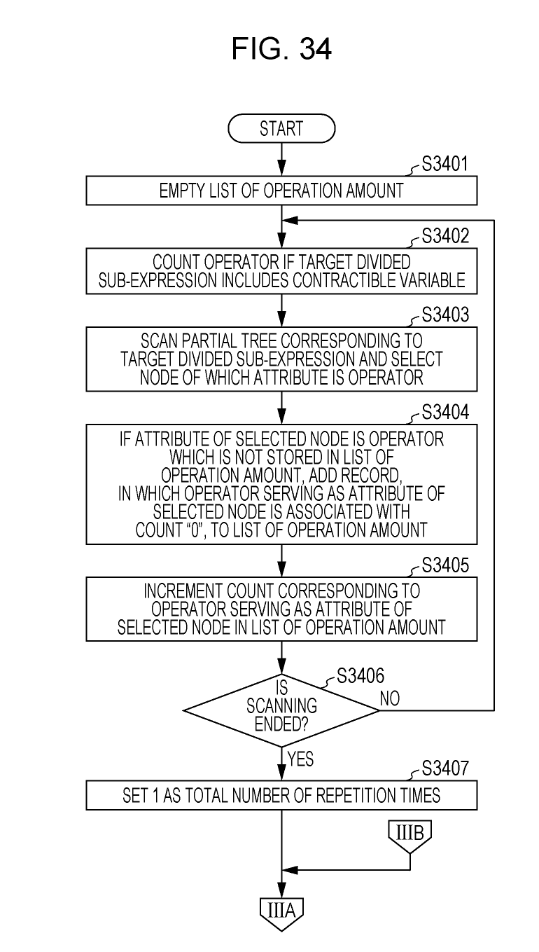

FIG. 33 is a flowchart illustrating an example of a procedural sequence of a reduction amount calculation process. In FIG. 33, the information processing apparatus 100 selects any of records of the list of divided sub-expressions (Step S3301). The information processing apparatus 100 sets one divided sub-expression of the selected record to the target divided sub-expression (Step S3302). The information processing apparatus 100 executes a calculation sub-process which is described later with reference to FIG. 34 (Step S3303). Thereafter, the information processing apparatus 100 sets the calculated total operation amount calculated by the calculation sub-process as the operation amount of one divided sub-expression (Step S3304).

The information processing apparatus 100 sets the other divided sub-expression of the selected record to the target divided sub-expression (Step S3305). The information processing apparatus 100 executes the calculation sub-process which is described later with reference to FIG. 34 (Step S3306). Thereafter, the information processing apparatus 100 sets the calculated total operation amount calculated by the calculation sub-process as the operation amount of one divided sub-expression (Step S3307).

The information processing apparatus 100 calculates the operation amount regarding binding between sub-expressions based on the number of repetition times regarding the parameter (Step S3308). The information processing apparatus 100 determines whether all records have been selected (Step S3309). In a case where an unselected record is present (Step S3309: No), the information processing apparatus 100 returns to the processing of Step S3301.

In a case where all records have been selected (Step S3309: Yes), the information processing apparatus 100 ends the reduction amount calculation process. With this, the information processing apparatus 100 may calculate the amount of operation regarding each sub-expression of the amount of operation after the loop split.

<<Example of Procedural Sequence of Calculation Sub-Process>>

Next, description is made on an example of a procedural sequence of a calculation sub-process indicated in Step S3303 and Step S3306 of FIG. 33 using FIG. 34 to FIG. 36.

FIG. 34 to FIG. 36 are flowcharts illustrating an example of a procedural sequence of a calculation sub-process. In FIG. 34, the information processing apparatus 100 empties the list of operation amount (Step S3401). Furthermore, the information processing apparatus 100 scans the partial tree corresponding to the target divided sub-expression, and if the target divided sub-expression includes the contractible variable, the information processing apparatus 100 adds a record in which the operator relating to the contraction operation is associated with count “1” to the list of operation amount (Step S3402).

The information processing apparatus 100 scans the partial tree corresponding to the target divided sub-expression and selects a node of which the attribute is an operator (Step S3403). If the attribute of the selected node is an operator which is not stored in the list of operation amount, the information processing apparatus 100 adds a record in which the operator serving as the attribute of the selected node is associated with count “0” to the list of operation amount (Step S3404).

The information processing apparatus 100 increments the count corresponding to the operator serving as the attribute of the selected node in the list of operation amount (Step S3405). The information processing apparatus 100 determines whether the scanning is ended (Step S3406). In a case where the scanning is not ended (Step S3406: No), the information processing apparatus 100 returns to the processing of Step S3402.

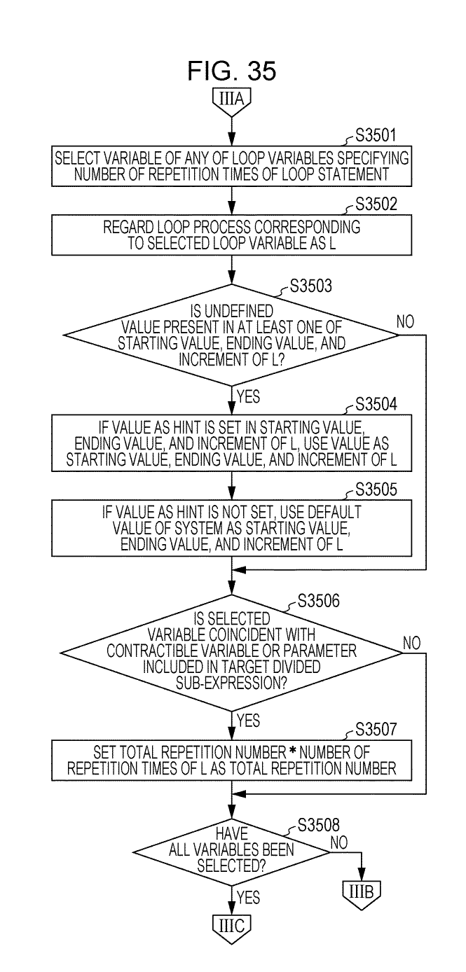

In a case where the scanning is ended (Step S3406: Yes), the information processing apparatus 100 sets 1 as the total number of the number of repetition times (Step S3407). The information processing apparatus 100 proceeds to the processing of Step S3501 of FIG. 35.

In FIG. 35, the information processing apparatus 100 selects a variable of any of loop variables specifying the number of repetition times of the loop statement (Step S3501). The information processing apparatus 100 regards the loop process corresponding to the selected loop variable as L (Step S3502).

The information processing apparatus 100 determines whether an undefined value is present in any of a starting value, an ending value, and an increment of L (Step S3503). In a case where the undefined value is not present (Step S3503: No), the information processing apparatus 100 proceeds to the processing of Step S3506.

In a case where the undefined value is present (Step S3503: Yes), if the value as a hint is set in the starting value, the ending value, and the increment of L, the information processing apparatus 100 uses the value as the starting value, the ending value, and the increment of L (Step S3504). Next, if the value as the hint is not set, the information processing apparatus 100 uses a default value of a system as the starting value, the ending value, and the increment of L (Step S3505).

The information processing apparatus 100 determines whether the selected variable coincides with the parameter or contractible variable included in the target divided sub-expression (Step S3506). In a case where the selected variable coincides with the parameter or contractible variable (Step S3506: Yes), the information processing apparatus 100 sets total repetition number*number of the number of repetition times of L as the total repetition number (Step S3507), and proceeds to the processing of Step S3508.

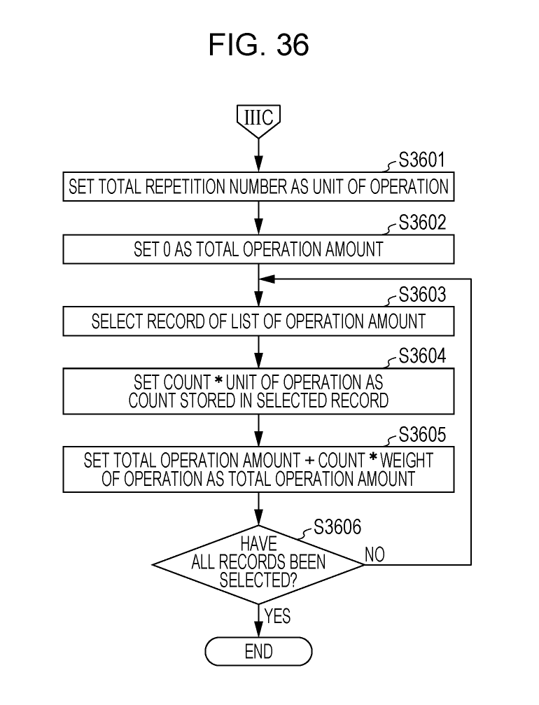

In a case where the selected variable does not coincide with the parameter or contractible variable (Step S3506: No), the information processing apparatus 100 determines whether all variables been selected (Step S3508). In a case where an unselected variable is present (Step S3508: No), the information processing apparatus 100 returns to the processing of Step S3501. In a case where all variables have been selected (Step S3508: Yes), the information processing apparatus 100 proceeds to the processing of Step S3601 of FIG. 36.

In FIG. 36, the information processing apparatus 100 sets the total repetition number as the unit of operation (Step S3601). The information processing apparatus 100 sets 0 as the total operation amount (Step S3602). The information processing apparatus 100 selects a record of the list of operation amount (Step S3603).

The information processing apparatus 100 sets count*unit of operation amount as a count stored in the selected record (Step S3604). The information processing apparatus 100 sets total operation amount+count*weight of operation as the total operation amount (Step S3605). The information processing apparatus 100 determines whether all records have been selected (Step S3606). In a case where an unselected record is present (Step S3606: No), the information processing apparatus 100 returns to the processing of Step S3603.

In a case where all records have been selected (Step S3606: Yes), the information processing apparatus 100 ends the calculation sub-process. With this, the information processing apparatus 100 may calculate the amount of operation regarding the target divided sub-expression of the amount of operation after the loop split.

<<Example of Procedural Sequence of Optimization Target Determination Process>>

Next, description is made on an example of a procedural sequence of an optimization target determination process indicated in Step S2008 of FIG. 20 using FIG. 37.

FIG. 37 is a flowchart illustrating an example of a procedural sequence of an optimization target determination process. In FIG. 37, the information processing apparatus 100 calculates an original operation amount (Step S3701). The information processing apparatus 100 selects any of sub-expressions of the list of the sub-expressions (Step S3702). The information processing apparatus 100 determines a combination in which the difference obtained by subtracting the operation amount of the divided sub-expression and the operation amount for binding from the original operation amount is the largest (=the maximum) of the combinations of the divided sub-expressions corresponding to the sub-expressions as an optimizing target, and adds the determined combination to the list of optimizing targets (Step S3703).

The information processing apparatus 100 determines whether all divided sub-expressions have been selected (Step S3704). In a case where an unselected sub-expression is present (Step S3704: No), the information processing apparatus 100 returns to the processing of Step S3702. In a case where all sub-expressions have been selected (Step S3704: Yes), the information processing apparatus 100 ends the optimization target determination process. With this, the information processing apparatus 100 may perform optimization using the sub-expression having the largest reduction amount.

<<Example of Procedural Sequence of AST Deformation Process>>

Next, description is made on an example of a procedural sequence of an AST deformation process indicated in Step S2009 of FIG. 20 using FIG. 38.

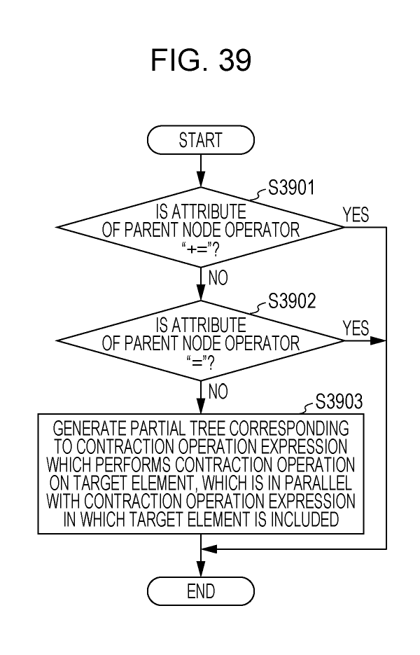

FIG. 38 is a flowchart illustrating an example of a procedural sequence of an AST deformation process. In FIG. 38, the information processing apparatus 100 selects a combination of divided sub-expressions of any of lists of optimizing targets as a target element (Step S3801). The information processing apparatus 100 executes a contraction operation expression insertion process, which is described later with reference to FIG. 39, regarding the selected target element (Step S3802). The information processing apparatus 100 executes a loop split process (Step S3803).

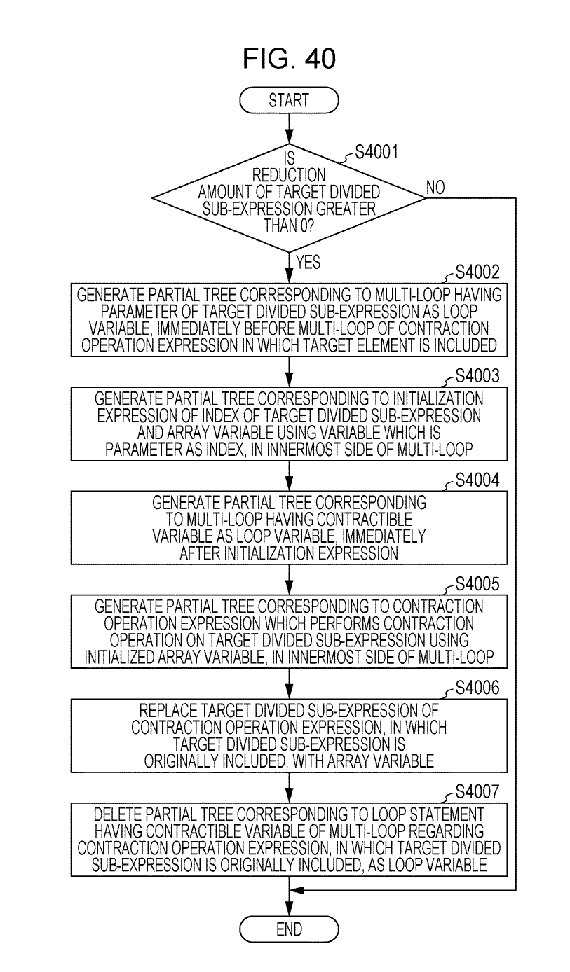

The information processing apparatus 100 sets one divided sub-expression of the target element as the target divided sub-expression (Step S3804). The information processing apparatus 100 executes a deformation sub-process, which is described later with reference to FIG. 40, regarding the target divided sub-expression (Step S3805).

The information processing apparatus 100 sets the other divided sub-expression of the target element as the target divided sub-expression (Step S3806). The information processing apparatus 100 executes a deformation sub-process, which is described later with reference to FIG. 40, regarding the target divided sub-expression (Step S3807).

The information processing apparatus 100 determines whether all combinations have been selected (Step S3808). In a case where an unselected combination is present (Step S3808: No), the information processing apparatus 100 returns to the processing of Step S3801.

In a case where all combinations have been selected (Step S3808: Yes), the information processing apparatus 100 ends the AST deformation process. With this, the information processing apparatus 100 may decrease the amount of operation during software execution.

<<Example of Procedural Sequence of Contraction Operation Expression Insertion Process>>

Next, description is made on an example of a procedural sequence of a contraction operation expression insertion process indicated in Step S3802 of FIG. 38 using FIG. 39.

FIG. 39 is a flowchart illustrating an example of a procedural sequence of a contraction operation expression insertion process. In FIG. 39, the information processing apparatus 100 determines whether an attribute of a parent node of the partial tree corresponding to the target element is an operator “+=” (Step S3901). In a case where the attribute is the operator “+=” (Step S3901: Yes), the information processing apparatus 100 ends the contraction operation expression insertion process.

In a case where the attribute is not the operator “+=” (Step S3901: No), the information processing apparatus 100 determines whether the attribute of the parent node of the partial tree corresponding to the target element is an operator “=” (Step S3902). In a case where the attribute is the operator “=” (Step S3902: Yes), the information processing apparatus 100 ends the contraction operation expression insertion process.

In a case where the attribute is not the operator “+” (Step S3902: No), the information processing apparatus 100 generates the partial tree corresponding to the contraction operation expression which performs the contraction operation on the target element, which is in parallel with contraction operation expression in which the target element is included (Step S3903). The information processing apparatus 100 ends the contraction operation expression insertion process. With this, the information processing apparatus 100 may insert the contraction operation expression as preparation for the deformation of the AST such that the amount of operation is decreased during software execution.

<<Example of Procedural Sequence of Deformation Sub-Process>>

Next, description is made on an example of a procedural sequence of a deformation sub-process indicated in Step S3805 or Step S3807 of FIG. 38 using FIG. 40.

FIG. 40 is a flowchart illustrating an example of a procedural sequence of a deformation sub-process. In FIG. 40, the information processing apparatus 100 determines whether a reduction amount of the target divided sub-expression is greater than 0 (zero) (Step S4001). In a case where the reduction amount is equal to or less than 0 (Step S4001: No), the information processing apparatus 100 ends the deformation sub-process.

In a case where the reduction amount is greater than 0 (Step S4001: Yes), the information processing apparatus 100 generates a partial tree corresponding to the multi-loop having the parameter of the target divided sub-expression as a loop variable, immediately before the multi-loop of contraction operation expression in which the target element is included (Step S4002). Next, the information processing apparatus 100 generates the partial tree corresponding to an initialization expression of the index of the target divided sub-expression and the array variable using a variable which is a parameter as an index, in the innermost side of the multi-loop (Step S4003)

The information processing apparatus 100 generates a partial tree corresponding to the multi-loop having the contractible variable as the loop variable, immediately after the initialization expression (Step S4004). The information processing apparatus 100 generates a partial tree corresponding to the contraction operation expression which performs the contraction operation on the target divided sub-expression using an initialized array variable in the innermost side of multi-loop (Step S4005). The information processing apparatus 100 replaces the target sub-expression of the contraction operation expression, in which the target divided sub-expression is originally included, with the array variable (Step S4006).

The information processing apparatus 100 deletes the partial tree corresponding to the loop statement having the contractible variable of the multi-loop for the contraction operation expression, in which the target divided sub-expression is originally included, as the loop variable (Step S4007). The information processing apparatus 100 ends the deformation sub-process. With this, the information processing apparatus 100 may deform the AST such that the amount of operation is decreased during software execution.

As has been described above, according to the information processing apparatus 100, it is possible to specify a loop portion in which the computation regarding a first expression, which performs a contraction operation with respect to a first variable, is repeated, of a program code. Next, according to the information processing apparatus 100, it is possible to generate a first code in which the computation regarding the second expression, which performs the contraction operation on a sub-expression of the first expression with respect to a second variable, is repeated and a second code in which the computation regarding the third expression, where the sub-expression of the first expression is replaced with the second variable, is repeated. According to the information processing apparatus 100, it is possible to output a program code obtained by transforming the loop portion of the program code into the first code and the second code. With this, the information processing apparatus 100 may decrease the amount of operation during software execution and achieve reduction of the processing time of software.

According to the information processing apparatus 100, it is possible to specify a type and the number of repetition times of the computation regarding the second expression and a type and the number of repetition times of the computation regarding the third expression, regarding each sub-expression of the first expression. According to the information processing apparatus 100, it is possible to calculate a difference between an amount of operation for the loop portion and a total of an amount of operation for the repetition of the computation regarding the second expression and an amount of operation for the repetition of the computation regarding the third expression, regarding each sub-expression of the first expression, based on the specified results. According to the information processing apparatus 100, it is possible to select any of sub-expressions of the first expression, based on the calculated difference, and generate a first code and a second code regarding any of the selected sub-expressions. With this, the information processing apparatus 100 may calculate an amount of operation to be decreased in a case where the program code is transformed. In a case where the program code is transformed, the information processing apparatus 100 may select the sub-expression used in the second expression such that the amount of operation during software execution is decreased to the maximum.

According to the information processing apparatus 100, it is possible to classify variables used in a condition to repeat the computation regarding the first expression into a first type variable and a second type variable different from the first type variable. According to the information processing apparatus 100, it is possible to specify the type and the number of repetition times of the computation regarding the second expression and the type and the number of repetition times of the computation regarding the third expression, regarding each sub-expression of the first expression, based on the classified results. With this, the information processing apparatus 100 may calculate the amount of operation to be decreased in a case where the loop portion is transformed into the first code or the second code even without generating the first code or the second code.

According to the information processing apparatus 100, it is possible to specify the number of repetition times and variables used in a condition to repeat the computation regarding the second expression and the number of the number of repetition times and variables used in a condition to repeat the computation regarding the third expression, regarding each sub-expression of the first expression. According to the information processing apparatus 100, it is possible to generate the first code using the loop statements and the second code using the loop statements, based on the specified variables and the number of repetition times. With this, the information processing apparatus 100 may generate the first code and the second code that do not include the loop statements that may not be used.

According to the information processing apparatus 100, it is possible to classify variables used in a condition to repeat the computation regarding the first expression into a first type variable and a second type variable different from the first type variable in each sub-expression of the first expression. According to the information processing apparatus 100, it is possible to specify the number of repetition times and variables used in a condition to repeat the computation regarding the second expression, regarding each sub-expression of the first expression, based on the classified results. According to the information processing apparatus 100, it is possible to specify the number of repetition times and variables used in a condition to repeat the computation regarding the third expression, regarding each sub-expression of the first expression, based on the classified results. With this, the information processing apparatus 100 may obtain information used when determining whether which loop statement is to be used in the first code and the second code.

According to the information processing apparatus 100, if the first expression is an expression which performs the contraction operation on the first variable by using a “first operator”, it is possible to adopt an expression which performs a sub-expression on the second variable by using a “first operator” which is the same operator, as the second expression. With this, the information processing apparatus 100 may generate the second expression such that a constant capable of being replaced with the sub-expression of the first expression is calculated as a value of the second variable.

<<Example of a Compile Method According to Embodiment 2>>

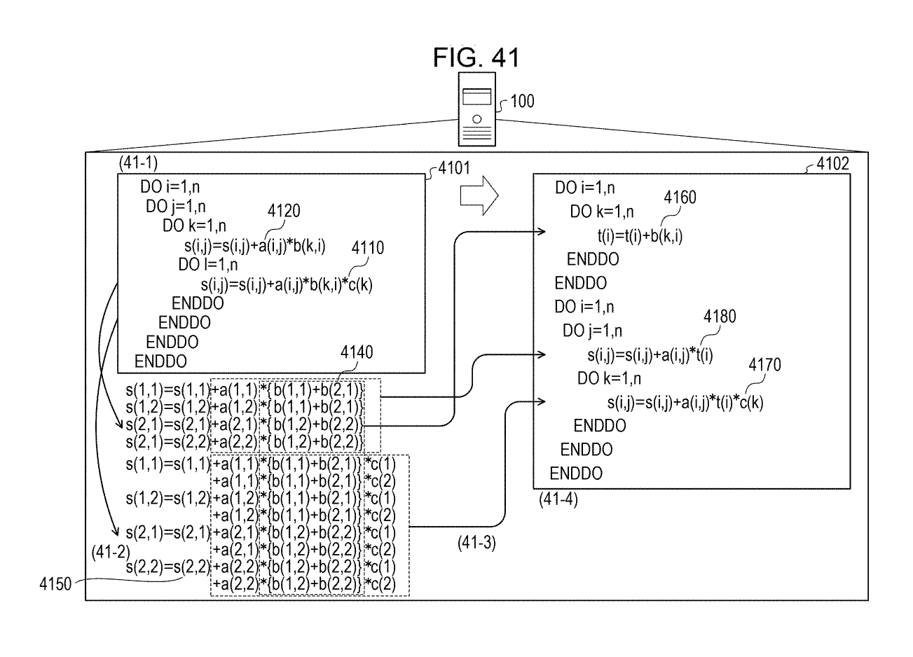

FIG. 41 is a diagram for explaining Example of a compile method according to Embodiment 2. In FIG. 41, the information processing apparatus 100 may change processing contents described in a program code within a range in which functionalities specified in the program code are not changed and achieve a reduction of the processing times of software.

As an optimization technique, there is, for example, a technique in which if the expressions having the same contents are present in a plurality of portions within the loop body in a single loop process, the computation regarding the expressions is performed on one portion once and each of the expressions of the plurality of portions is replaced with the computation result of the expression performed on one portion.

However, in a case where there are plurality of expressions computed through a plurality of loop process of a multi-loop process having a nest structure in which the expression performing the contraction operation is included, the optimization technique described above unable to be applied even when the expression having the same contents is included in each collection. Therefore, for the multi-loop in which the expression performing the contraction operation is included, there is a case where it is not known how to change processing contents in order to decrease the amount of operation and it is not possible to decrease the processing time for software.

In the present embodiment, description is made on a compile method of achieving a reduction of the processing time of software by changing processing contents regarding the multi-loop process in which the expression performing the contraction operation is included and reducing the amount of operation during software execution.

In the example of FIG. 41, description is made on an operation of the information processing apparatus 100 by using the source code 4101 in which a loop portion, where computation regarding an expression 4110 and computation regarding an expression 4120 is repeated, is described, is described as an example of a program code.

The expression 4110 is “s(i,j)=s(i,j)+a(i,j)*b(l,i)*c(k)”. The expression 4110 is an expression which performs the contraction operation on a variable “a(i,j)”, a variable “b(l,i)”, or a variable “c(k)” with respect to a first variable “s(i,j)”. The expression 4120 is “s(i,j)=s(i,j)+a(i,j) * b(k,i)”. The expression 4120 is an expression which performs the contraction operation on a variable “a(i,j)” or a variable “b(k,i)” with respect to the first variable “s(i,j)”.

Here, for example, in a case of n=2, first processing contents in which the computation regarding the expression 4110 is repeated in the loop portion may be changed to second processing contents in which the computation regarding the following expressions (9) to (12) denoted by a reference numeral 4140 is performed, without changing the functionality. With this, in the second processing contents, the number of operators is decreased to be less than that of the first processing contents and thus, the amount of operation is decreased.

s(1,1)=s(1,1)+a(1,1)*{b(1,1)+b(2,1)} (9)

s(1,2)=s(1,2)+a(1,2)*{b(1,1)+b(2,1)} (10)

s(2,1)=s(2,1)+a(2,1)*{b(1,2)+b(2,2)} (11)

s(2,2)=s(2,2)+a(2,2)*{b(1,2)+b(2,2)} (12)

Furthermore, for example, in a case of n=2, third processing contents in which the computation regarding the expression 4120 is repeated in the loop portion may be changed to fourth processing contents in which the computation regarding the following expressions (13) to (16) denoted by a reference numeral 4150 is performed, without changing the functionality. With this, in the fourth processing contents, the number of operators is decreased to be less than that of the third processing contents and thus, the amount of operation is decreased.

s(1,1)=s(1,1)+a(1,1)*{b(1,1)+b(2,1)}*c(1)+a(1,1)*{b(1,1)+b(2,1)}*c(2) (13)

s(1,2)=s(1,2)+a(1,2)*{b(1,1)+b(2,1)}*c(1)+a(1,2)*{b(1,1)+b(2,1)}*c(2) (14)

s(2,1)=s(2,1)+a(2,1)*{b(1,2)+b(2,2)}*c(1)+a(2,1)*{b(1,2)+b(2,2)}*c(2) (15)

s(2,2)=s(2,2)+a(2,2)*{b(1,2)+b(2,2)}*c(1)+a(2,2)*{b(1,2)+b(2,2)}*c(2) (16)

The second processing contents and the fourth processing contents include the expression having the same content which is common to a plurality of expressions and may be handled as a constant. Therefore, since the second processing contents and the fourth processing contents described above perform computation regarding the expression having the same content without changing functionalities, the second processing contents and the fourth processing contents may be changed into fifth processing contents in which the computation regarding the following expressions (9) to (16) is performed using the results obtained by the computation.

For example after performing the computation regarding the expression “b(1,1)+b(2,1)” or the expression “b(1,1)+b(2,2)”, the computation regarding the expressions (9) to (16) is performed using the result obtained by the computation. With this, in the fifth processing contents, the computation regarding the expression having the same content, which is common to a plurality of expressions and may be handled as a constant, may not be performed plural times and thus, the amount of operation is decreased.

In this manner, in a case where there are a plurality of collections of the expressions computed through a plurality of loop processes, in a case where an expression which is common to respective collections and is capable of being handled as a constant is included, the amount of operation may be decreased if the processing contents described in the source code 4101 are changed. Therefore, the information processing apparatus 100 transforms the loop portion of the source code 4101 to output a source code 4102 after the transformation such that a reduction of the amount of operation by the change of the processing contents described above is implemented.

<(41-1) In the Example of FIG. 41>

The information processing apparatus 100 acquires the source code 4101. Next, the information processing apparatus 100 performs lexical analysis and grammar analysis with respect to the source code 4101 and prepares an abstract syntax tree corresponding to the source code 4101. The information processing apparatus 100 specifies a loop portion in which the computation regarding the expression 4110 “s(i,j)=s(i,j)+a(i,j)*b(l,i)*c(k)” is repeated which is described in the source code 4101 based on the abstract syntax tree. The information processing apparatus 100 specifies the sub-expression “b(l,i)” of the expression 4110.

<(41-2) In the Example of FIG. 41>

The information processing apparatus 100 specifies the expression 4120 “s(i,j)=s(i,j)+a(i,j)*b(k,i)” which is present in the specified loop portion and is different from the expression 4110. The information processing apparatus 100 specifies another sub-expression “b(k,i)” which at least has the same variable and relationship between variables as those of the sub-expression “b(l,i)” of the expression 4110, of the expression 4120.

<(41-3) In the Example of FIG. 41>

The information processing apparatus 100 generates a first code in which the computation regarding the expression 4160 “t(i)=t(i)+b(k,i)”, which performs the contraction operation on the specified other sub-expression “b(k,i)” with respect to a second variable “t(i)”, is repeated. The expression 4160 is equivalent to an expression “t(i)=t(i)+b(l,i)” which performs the contraction operation on the sub-expression “b(l,i)” of the expression 4110 with respect to the second variable “t(i)”. The first code is a code corresponding to the processing contents in which the computation regarding the expression “b(1,1)+b(2,1)” or the expression “b(1,1)+b(2,2)” described above is performed. The second variable is a variable capable of being replaced with each of the sub-expression of the expression 4110 and the other sub-expression of the expression 4120.

The information processing apparatus 100 specifies the expression 4170 “s(i,j)=s(i,j)+a(i,j)*t(i)*c(k)” in which the sub-expression of the expression 4110 is replaced with the second variable. The information processing apparatus 100 specifies the expression 4180 “s(i,j)=s(i,j)+a(i,j)*t(i)” in which the other sub-expression of the expression 4120 is replaced with the second variable. The information processing apparatus 100 generates a second code in which the computation regarding the expression 4170 and the expression 4180 is repeated. The second code is a code corresponding to the processing contents in which the computation regarding the expressions (9) to (16) is performed using the result obtained by the computation regarding the expression “b(1,1)+b(2,1)” or the expression “b(1,1)+b(2,2)”.

<(41-4) In the Example of FIG. 41>

The information processing apparatus 100 transforms the loop portion of the source code 4101 into the first code and the second code. The information processing apparatus 100 outputs the source code 4102 after the transformation to the display device and transmits the source code 4102 to another computer or stores the source code 4102 in a storage device.

In this manner, according to the information processing apparatus 100, it is possible to generate the first code which includes the expression 4160 collectively calculating an operation result, which is obtained in a case where the contraction operation is performed on each of the sub-expressions of the expression 4110 which performs the contraction operation and the other sub-expression of the expression 4120 which performs the contraction operation, at once. According to the information processing apparatus 100, it is possible to transform the loop portion of the source code 4101 into the first code and the second code which indicates the loop process including the expression 4170 and the expression 4180 which use the operation result. With this, the information processing apparatus 100 may prepare the expression 4160, which is common to the collection of the plurality of expressions computed through a plurality of loop processes and is capable of being handled as a constant, and transform the source code 4101 such that the computation regarding the expression 4160 is performed in advance.

As a result, the information processing apparatus 100 may decrease the amount of operation during software execution and achieve a reduction of the processing time of software. For example, in the source code 4101, an addition “+” and a multiplication “*” are repeatedly executed “n̂3” times and the addition “+” and the multiplication “*” for two times are repeatedly executed “n̂4” times. Therefore, the amount of operation is “2n̂3+3n̂4” in the source code 4101.

In contrast, in the source code 4102 after the transformation, an addition “+” is repeatedly executed “n̂2” times, and the addition “+” and the multiplication “*” are repeatedly executed “n̂2” times, and the addition “+” and the multiplication “*” for two times are repeatedly executed “n̂3” times. Therefore, the amount of operation is “n̂2+2n̂2+3n̂3” in the source code 4102 after the transformation. As a result, if n>2, the amount of operation is decreased in the source code 4102 after the transformation.

Although description has been made on a case where the expression 4170 and the expression 4180 are collectively included in a single loop process, the present disclosure is not limited thereto. For example, the information processing apparatus 100 may adopt a combination of a code indicating the loop process which includes the expression 4170 and a code indicating the loop process which includes the expression 4180, instead of the second code.

<<Example of Hardware Configuration of Information Processing Apparatus 100 According to Embodiment 2>>

Next, an example of a hardware configuration of the information processing apparatus 100 is described. The hardware configuration of the information processing apparatus 100 is similar to the hardware configuration illustrated in FIG. 2, and thus description thereof will not be repeated.

<<Example of Functional Configuration of Information Processing Apparatus 100 According to Embodiment 2>>

Next, an example of a functional configuration of the information processing apparatus 100 is described. The information processing apparatus 100 includes the specifying section 301, the classifying section 302, the calculation section 303, the selecting section 304, the generation section 305, and the output section 306 as illustrated in FIG. 3.

The specifying section 301, similar to Embodiment 1, specifies a loop portion in which the computation regarding a first expression, which performs the contraction operation with respect to a first variable, is repeated, in a program code of software. The specifying section 301 specifies the sub-expression of the first expression. The specifying section 301 specifies another sub-expression which is present within the specified loop portion and at least has the same variable and relationship between variables as those of the sub-expression of the first expression, among the fourth expression which performs the contraction operation with respect to the third variable.

The specifying section 301 specifies, for example, a loop portion in which the computation regarding the first expression “s(i,j)=s(i,j)+a(i,j)*b(l,i)*c(k)” is repeated. The specifying section 301 specifies the sub-expression “b(l,i)” of the first expression or the like. The specifying section 301 specifies the fourth expression “s(i,j)=s(i,j)+a(i,j)*b(k,i)” which is present in the loop portion. The specifying section 301 specifies the sub-expression “b(k,i)” of the fourth expression which has a different index and the same variable and the relationship between the variables, for the sub-expression “b(l,i)” of the first expression. With this, the specifying section 301 may specify the loop portion having a possibility that the amount of operation during software execution is decreased.

The classifying section 302, similar to Embodiment 1, classifies a variable used in a condition to repeat the computation regarding the first expression into a first type variable in the sub-expression of the first expression and a second type variable different from the first type variable. The classifying section 302, classifies a variable used in a condition to repeat the computation regarding the fourth expression into a first type variable in the sub-expression of the fourth expression and a second type variable different from the first type variable. With this, the classifying section 302 may obtain information used when calculating the amount of operation to be decreased in a case of transforming the loop portion, based on the combination of the sub-expression of the first expression and the sub-expression of the fourth expression is calculated.

The calculation section 303 specifies a type and the number of repetition times of the computation regarding the second expression, which performs the contraction operation on each specified sub-expression with respect to the second variable, regarding the sub-expression of the fourth expression. The second variable is a variable capable of being replaced with the sub-expression of the first expression and the sub-expression of the fourth expression. The calculation section 303 specifies a type and the number of repetition times of the computation regarding the third expression in which the sub-expression of the first expression is replaced with the second variable. The calculation section 303 specifies a type and the number of repetition times of the computation regarding the fifth expression in which the sub-expression of the fourth expression is replaced with the second variable.

The calculation section 303 calculates a difference between an amount of operation for the loop portion and a total of an amount of operation for the repetition of the computation regarding the second expression, an amount of operation for the repetition of the computation regarding the third expression, and an amount of operation for the repetition of the computation regarding the fifth expression, based on the specified type and the number of repetition times.

The calculation section 303 specifies a type and the number of repetition times of the computation regarding the second expression which performs the contraction operation on the sub-expression with respect to the second variable, regarding each specified sub-expression of the fourth expression, based on the classified result. The calculation section 303 specifies a type and the number of repetition times of the computation regarding the third expression in which the sub-expression of the first expression is replaced with the second variable, regarding each specified sub-expression of the first expression, based on the classified result. The calculation section 303 specifies a type and the number of repetition times of the computation regarding the fifth expression in which the sub-expression of the fourth expression is replaced with the second variable, regarding each specified sub-expression of the fourth expression, based on the classified result.

The calculation section 303 calculates a value obtained by multiplying the number of operators for each specified type regarding the second expression and the number of repetition times as an amount of operation for the repetition of the computation regarding the second expression. The calculation section 303 calculates a value obtained by multiplying the number of operators for each specified type regarding the third expression and the number of repetition times as an amount of operation for the repetition of the computation regarding the third expression. The calculation section 303 calculates a value obtained by multiplying the number of operators for each specified type regarding the fifth expression and the number of repetition times as an amount of operation for the repetition of the computation regarding the fifth expression.

The calculation section 303 calculates a difference between an amount of operation for the loop portion and a total of an amount of operation for the repetition of the computation regarding the second expression, an amount of operation for the repetition of the computation regarding the fifth expression, and an amount of operation for the repetition of the computation regarding the third expression. With this, the calculation section 303 may specify the amount of operation in a case where the program code is transformed.

The selecting section 304 selects any of the sub-expressions of the fourth expression, based on the difference calculated by the calculation section 303. The selecting section 304 selects a combination of sub-expressions of the fourth expression having the largest difference calculated by the calculation section 303. With this, the selecting section 304 may select a sub-expression used in a case of transforming the program code such that the amount of operation during software execution is decreased to the maximum.

The generation section 305 generates a first code in which computation regarding the second expression, which performs the contraction operation on the sub-expression of the selected fourth expression with respect to the second variable, is repeated. The generation section 305 specifies the sub-expression of the first expression having the same variable and relationship between variables as those of the sub-expression of the selected fourth expression. The generation section 305 generates a second code in which computation regarding the third expression where the sub-expression of the first expression is replaced with the second variable is repeated and in which computation regarding the fifth expression where the other sub-expression of the fourth expression is replaced with the second variable is repeated. The generation section 305 generates, for example, the first code and the second code regarding the combination of the selected sub-expressions.

Specifically, the generation section 305 specifies variables and the number of repetition times used in a condition to repeat the computation regarding the second expression that performs the contraction operation on the specified sub-expression, regarding each specified sub-expression of the fourth expression. The generation section 305 specifies variables and the number of repetition times used in a condition to repeat the computation regarding the third expression in which the sub-expression of the first expression is replaced with the second variable. The generation section 305 specifies variables and the number of repetition times used in a condition to repeat the computation regarding the fifth expression in which the sub-expression of the fourth expression is replaced with the second variable. The generation section 305 generates the first code using a loop statement and the second code using a loop statement, based on the specified variables and the number of repetition times.

More specifically, the generation section 305 specifies the variables and the number of repetition times described above based on the classified result. The generation section 305 generates the first code using a loop statement and the second code using a loop statement, based on the specified variables and the number of repetition times. With this, the generation section 305 may generate a program code capable of reducing the amount of operation during software execution.

The output section 306 outputs a transformed program code obtained by transforming the loop portion of the program code into the first code and the second code, similar to Embodiment 1. With this, the output section 306 may provide the transformed program code to a compiler.

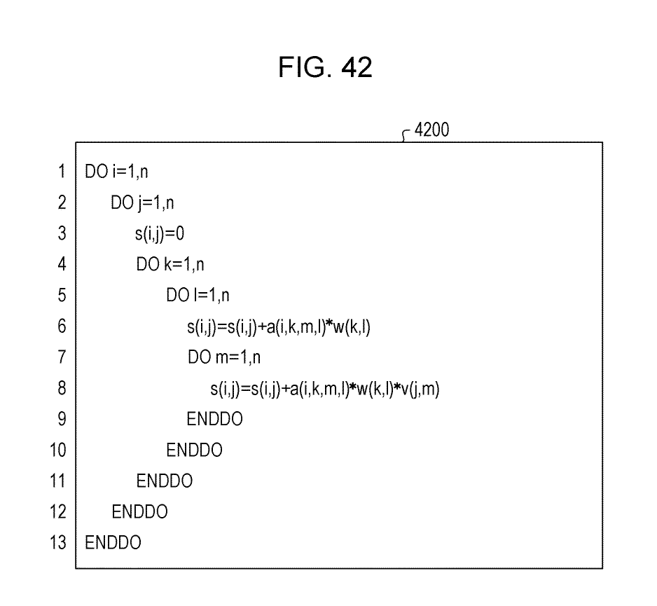

Next, an example of operations of the information processing apparatus 100 according to Embodiment 2 will be described with reference to FIG. 42 to FIG. 46.

<<Example of Source Code 4200 According to Embodiment 2>>

FIG. 42 is a diagram for explaining a source code 4200 according to Embodiment 2. In the example of FIG. 42, a loop statement “DO i=1, n (loop body) ENDDO” is described in the first row and the thirteenth row of the source code 4200. The loop body which is repeatedly executed by the loop statement “DO i=1, n (loop body) ENDDO” is described in a portion from the second row to the twelfth row of the source code 4200. With this, contents of the loop process, which repeatedly executes the processing within the loop body until the variable i reaches n, where the variable i begins from 1, are described in a portion from the first row to the thirteenth row of the source code 4200.

A loop statement “DO j=1, n (loop body) ENDDO” is described in the second row and the twelfth row of the source code 4200. The loop body which is repeatedly executed by the loop statement “DO j=1, n (loop body) ENDDO” is described in a portion from the third row to the eleventh row of the source code 4200. With this, contents of the loop process, which repeatedly executes the processing within the loop body until the variable j reaches n, where the variable j begins from 1, are described in a portion from the second row to the twelfth row of the source code 4200.

An assignment statement “s(i,j)=0” is described in the third row of the source code 4200. With this, contents of an initialization processing for assigning a numerical value “0” to a value of an array variable s(i,j) are described in the third row of the source code 4200.

A loop statement “DO k=1, n (loop body) ENDDO” is described the fourth row and the eleventh row of the source code 4200. The loop body which is repeatedly executed by the loop statement “DO k=1, n (loop body) ENDDO” is described in a portion from the fifth row to the tenth row of the source code 4200. With this, contents of the loop process, which repeatedly executes the processing within the loop body until the variable k reaches n, where the variable k begins from 1, are described in a portion from the fourth row to the eleventh row of the source code 4200.

A loop statement “DO l=1, n (loop body) ENDDO” is described in the fifth row and the tenth row of the source code 4200. The loop body which is repeatedly executed by the loop statement “DO l=1, n (loop body) ENDDO” is described in a portion from the sixth row to the ninth row of the source code 4200. With this, contents of the loop, which repeatedly executes the processing within the loop body until the variable l reaches n, where the variable l begins from 1, are described in a portion from the fifth row to the tenth row of the source code 4200.

An assignment statement “s(i,j)=s(i,j)+a(i,k,j,l)*w(k,l)” is described in the sixth row of the source code 4200. With this, contents of an assignment processing for assigning a value of array variable s(i,j)+array variable a(i,k,j,l)*array variable w(k,l) to a value of an array variable s(i,j) are described in the sixth row of the source code 4200.

A loop statement “DO m=1, n (loop body) ENDDO” is described in the seventh row and the ninth row of the source code 4200. The loop body which is repeatedly executed by the loop statement “DO m=1, n (loop body) ENDDO” is described in the eighth row of the source code 4200. With this, contents of the loop process, which repeatedly executes the processing within the loop body until the variable m reaches n, where the variable m begins from 1, are described in a portion from the seventh row to the ninth row of the source code 4200.

An assignment statement “s(i,j)=s(i,j)+a(i,k,m,l)*w(k,l)*v(j,m)” is described in the eighth row of the source code 4200. With this, contents of an assignment processing for assigning a value of array variable s(i,j)+array variable a(i,k,m,l)*array variable w(k,l)*array variable v(j,m) to a value of an array variable s(i,j) are described in the eighth row of the source code 4200.

In this manner, a portion from the first row to the thirteenth row of the source code 4200 is a multi-loop portion in which a collection of a plurality of loop statements having a nest structure is described. The portion from the first to the third rows, the twelfth row and the thirteenth row of the source code 4200 is a multi-loop portion in which a collection of a plurality of loop statements having a nest structure is described and which changes the variables i and j, switches an array variable s(i,j) on which the contraction operation is performed, and initializes the switched array variable s(i,j).

The fourth row to the eleventh row of the source code 4200 is a multi-loop portion in which a collection of a plurality of loop statements having a nest is described and which performs the contraction operation with respect to the initialized array variable s(i,j) by repeating an assignment operation with respect to the initialized array variable s(i,j).

<<Example of Canonicalization of Sub-Expression>>

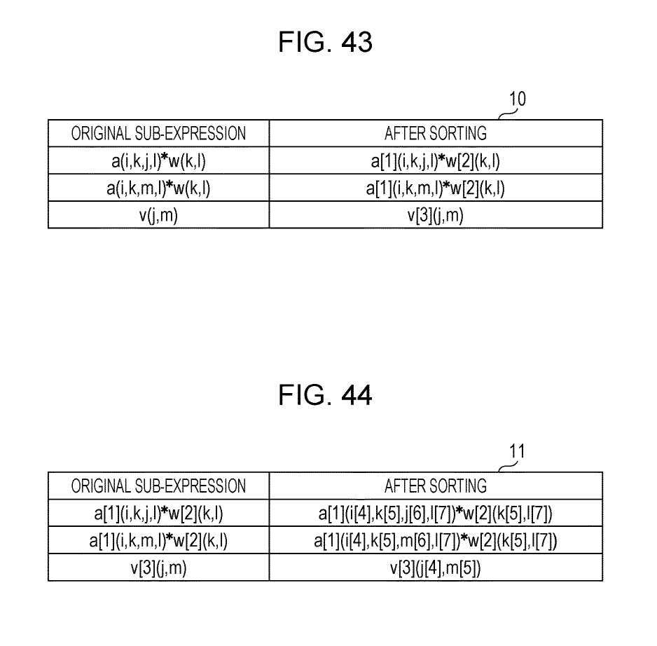

FIG. 43 to FIG. 45 are diagrams illustrating an example of canonicalization of a sub-expression. The information processing apparatus 100 sorts terms within a sub-expression, allocates numbers to the variables within the sub-expression, and canonicalizes the sub-expression after extracting the sub-expression similar to Embodiment 1.

In FIG. 43, the information processing apparatus 100 generates, for example, a list 10 storing the sorted result of the terms within the sub-expression. Next, the information processing apparatus 100 extracts the sub-expression from the list of sub-expressions.

The information processing apparatus 100 sorts terms of the sub-expression in ascending order of a depth of a node having an operator as an attribute in the AST. If the terms of the sub-expression having the same depth are present, the information processing apparatus 100 sorts the terms in descending order of a priority level of an operator. If the terms of the sub-expression having the same priority level are present, the information processing apparatus 100 sorts the terms in order of a number allocated, by a compiler, to a variable to be referenced or in alphabetical order.

The information processing apparatus 100 allocates a number to each variable according to the sorted order. The information processing apparatus 100 allocates, for example, the number “1” to the variable a(i, k, j, l). The information processing apparatus 100 allocates, for example, the number “2” to the variable w(k, l). The information processing apparatus 100 allocates, for example, the number “3” to the variable v(k, l). If a constant is present in the sub-expression, the information processing apparatus 100 handles the constant similar to the variable, allocates a number to the constant, and arranges the constant ahead of the variable.

In FIG. 44, the information processing apparatus 100 allocates a number to the loop variable according to a sequence appearing from the top of the sub-expression regarding the loop variable. In this case, the information processing apparatus 100 does not handle the index of the same array variable associated in a column of commutable operators as an index which has appeared. Since the number is allocated the loop variable according to the sequence which appeared for each sub-expression regarding the loop variable, even a variable to which the same number is allocated in the different sub-expression may be a different variable.

Furthermore, the information processing apparatus 100 sorts the terms of the sub-expression again after the numbers are allocated to the loop variables. If a loop variable to which the number is not allocated is present, the information processing apparatus 100 allocates a number to the loop variable. The information processing apparatus 100 stores the result of allocation of numbers in the list 11.

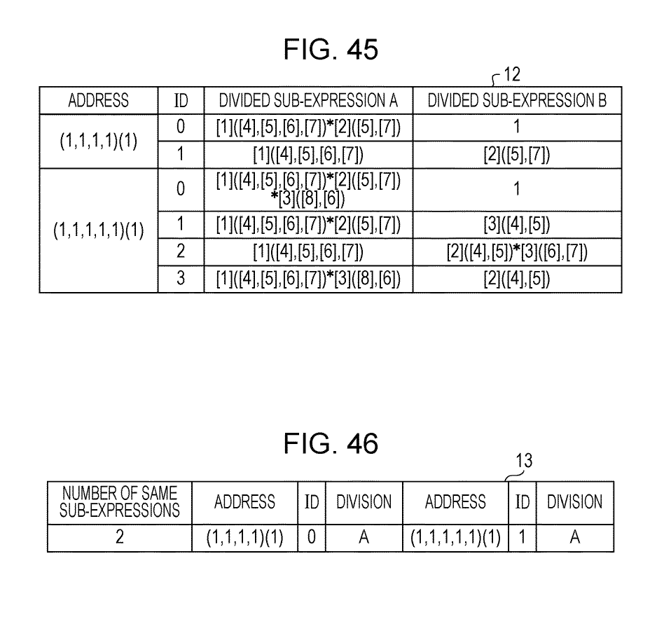

In FIG. 45, the information processing apparatus 100 generates a list of the divided sub-expressions similar to Embodiment 1. The information processing apparatus 100 generates a list 12 of the divided sub-expressions to which the numbers are allocated based on the list of the divided sub-expressions and the list 11.

<<Example of Specifying of Common Sub-Expression>>

FIG. 46 is a diagram for explaining an example of specifying of a common sub-expression. The information processing apparatus 100 specifies the sub-expression which is common after classifying the scalar variables similar to Embodiment 1.

In FIG. 46, the information processing apparatus 100 generates a list 13 storing a combination of the sub-expressions having at least the same variable and relationship between variables. For brevity of description, in a case where three or more sub-expressions are capable of being combined, a list is implemented using a plurality of records each storing the combination of two sub-expressions.

The information processing apparatus 100 extracts a combination of divided sub-expressions that are associated with different addresses and that is a combination of sub-expressions that at least have the same variable and relationship between variables of the divided sub-expressions of the list 12, and adds the extracted combination to the list 13. The information processing apparatus 100 extracts a combination of divided sub-expressions that are stored in the same record and that is a combination of sub-expressions that at least have the same variable and relationship between variables of divided sub-expressions the list 12, and adds the extracted combination to the list 13.

Thereafter, the information processing apparatus 100 calculates a reduction amount similar to Embodiment 1. In this case where an operation result, which is obtained in a case where the contraction operation is performed on each of the combinations of the divided sub-expressions that at least have the same variable and relationship between variables, is collectively calculated at once, the information processing apparatus 100 handles one operation amount of the combinations as 0. The information processing apparatus 100 determines the sub-expression to be optimized to optimize the source code 4200 similar to Embodiment 1.

<<Example of Optimization of Source Code 4200>>

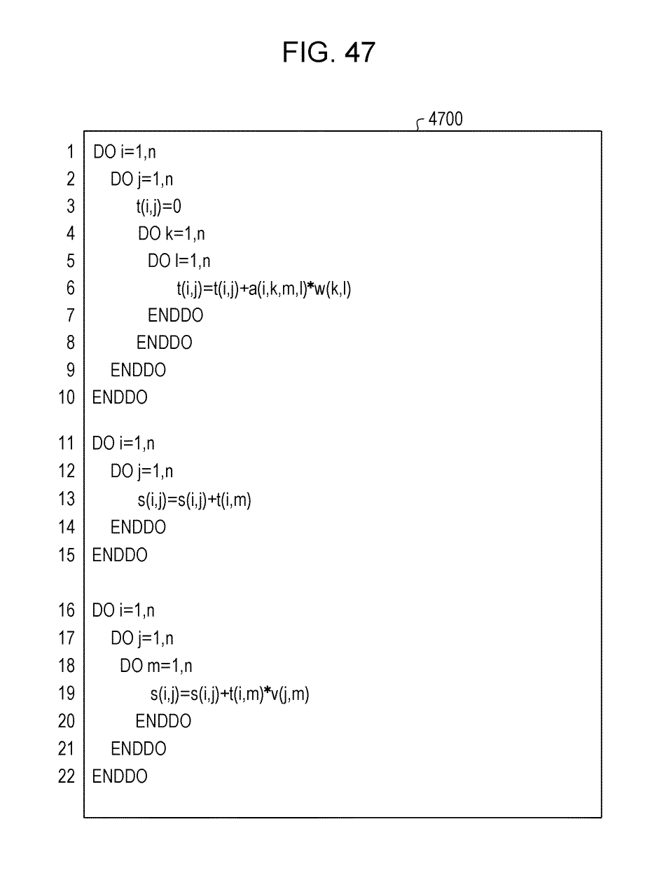

FIG. 47 is a diagram for explaining an example of optimization of the source code 4200. The example of FIG. 47 is an example of a source code 4700 obtained by optimizing the source code 4200.

In the example of FIG. 47, a portion from the first row to the tenth row of the source code 4700 is a portion in which the same contents of a portion from the first row to the tenth row of the source code 1800 illustrated in FIG. 18 are described and thus, description thereof will not be repeated. In this manner, a portion from the first row to the tenth row of the source code 4700 is a contraction operation multi-loop portion in which computation regarding the variable t(i,j) capable of being replaced with the sub-expressions of the plurality of portions within the source code is performed and a collection of a plurality of loop statements having a nest structure is described.

A portion from the eleventh row to the fifteenth row of the source code 4700 is a portion in which the same contents of a portion from the eleventh row to the eighteenth row of the source code 1800 indicated in FIG. 18 are described except for the portion corresponding to the initialization process and thus, description thereof will not be repeated. In this manner, the eleventh row to the fifteenth row of the source code 4700 is a contraction operation multi-loop portion in which the computation with respect to the array variable s(i,j) is performed and a collection of a plurality of loop statements having a nest structure is described.

A portion from the sixteenth row to the twenty-second row of the source code 4700 is a portion in which the same contents of a portion from the eleventh row to the eighteenth row of the source code 1800 indicated in FIG. 18 are described except for the portion corresponding to the initialization process and thus, description thereof will not be repeated. In this manner, the sixteenth row to the twenty-second row of the source code 4700 is a contraction operation multi-loop portion in which the computation with respect to the array variable s(i,j) is performed and a collection of a plurality of loop statements having a nest structure is described.

<<Example of Procedural Sequence of Compile Process According to Embodiment 2>>

An example of a procedural sequence of a compile process according to Embodiment 2 is similar to the example of the procedural sequence of the compile process according to Embodiment 1 illustrated in FIG. 19 and thus, description thereof will not be repeated. Furthermore, various procedural sequences called from the procedural sequence of the compile process are similar to various procedural sequences according to Embodiment 1 illustrated in FIG. 21 to FIG. 40, except for the procedural sequence of the reduction amount calculation process and the procedural sequence of optimization target determination process, and thus, description thereof will not be repeated.

<<Example of Procedural Sequence of Reduction Amount Calculation Process According to Embodiment 2>>

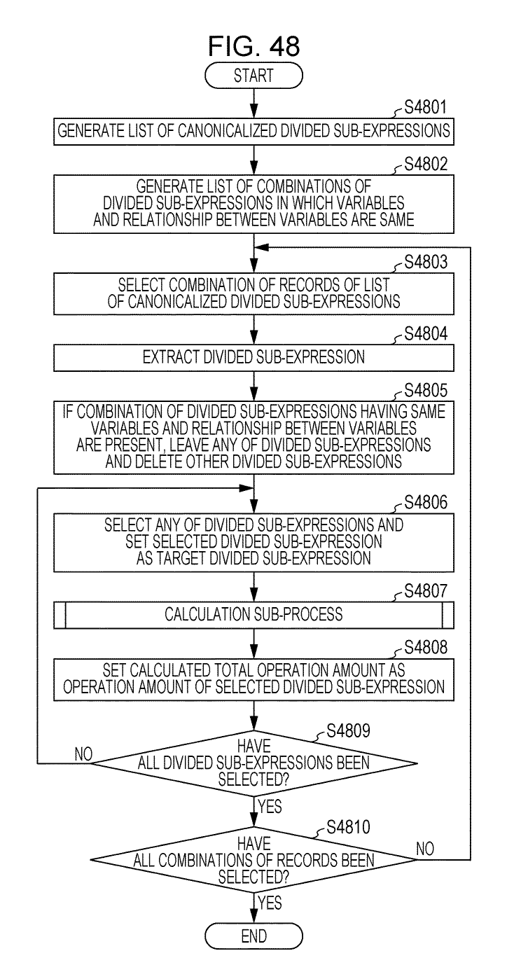

Next, an example of a procedural sequence of a reduction amount calculation process according to Embodiment 2 will be described using FIG. 48.

FIG. 48 is a flowchart illustrating an example of a procedural sequence of a reduction amount calculation process according to Embodiment 2. In FIG. 48, the information processing apparatus 100 generates a list of canonicalized divided sub-expressions based on the list of the divided sub-expression (Step S4801).

Next, the information processing apparatus 100 generates a list of combinations of divided sub-expressions having the same variable and the relationship between variables is the same based on the list of the canonicalized divided sub-expressions (Step S4802). The information processing apparatus 100 selects a combination of records of the lists of canonicalized divided sub-expressions (Step S4803).

Next, the information processing apparatus 100 extracts the divided sub-expression from the selected combination of records (Step S4804). If the combination of the divided sub-expressions having the same variable and the relationship between variables is present in the extracted divided sub-expressions, the information processing apparatus 100 leaves any of the divided sub-expressions and deletes other divided sub-expressions (Step S4805).

Next, the information processing apparatus 100 selects any of the divided sub-expressions and sets the selected divided sub-expression to a target divided sub-expression (Step S4806). The information processing apparatus 100 executes a calculation sub-process (Step S4807).

The information processing apparatus 100 sets the total operation amount calculated by the calculation sub-process as an operation amount of the selected divided sub-expression (Step S4808). The information processing apparatus 100 determines whether all divided sub-expressions have been selected (Step S4809). In a case where an unselected divided sub-expression is present (Step S4809: No), the information processing apparatus 100 returns to Step S4806.

In a case where all divided sub-expressions have been selected (Step S4809: Yes), the information processing apparatus 100 determines whether all combinations of records have been selected (Step S4810). In a case where an unselected divided sub-expression is present (Step S4810: No), the information processing apparatus 100 returns to Step S4803.

In a case where all combinations of records have been selected (Step S4810: Yes), the information processing apparatus 100 ends the reduction amount calculation process. With this, the information processing apparatus 100 may calculate the reduction amount.

<<Example of Procedural Sequence of Optimization Target Determination Process According to Embodiment 2>>

An example of a procedural sequence of an optimization target determination process according to Embodiment 2 will be described. The information processing apparatus 100 determines a combination in which the difference obtained by subtracting the total of the calculated operation amount of the divided sub-expression from the original operation amount is the largest as the optimizing target, among the combinations of the records of the list of the canonicalized divided sub-expressions.

As having been described above, according to the information processing apparatus 100, it is possible to specify another sub-expression which has at least the same variable and relationship between variables as those of the sub-expression of the first expression, of the fourth expression which performs the contraction operation with respect to the third variable which is present within the specified loop portion. According to the information processing apparatus 100, it is possible to generate a first code, and a second code in which computation regarding the third expression, where the sub-expression of the first expression is replaced with the second variable, is repeated and in which computation regarding the fifth expression, where the other sub-expression of the fourth expression is replaced with the second variable, is repeated.

With this, the information processing apparatus 100 may generate the first code which indicates the loop process including the second expression which may collectively calculate an operation result, which is obtained in a case where the contraction operation is performed on each of the sub-expression of the first expression which performs the contraction operation and the other sub-expression of the fourth expression which performs the contraction operation, at once. According to the information processing apparatus 100, it is possible to transform the loop portion of the source code into the first code and the second code which indicates the loop process including the first expression which uses the operation result in the first code and the loop process including the fourth expression which uses the operation result in the first code the expression. With this, the information processing apparatus 100 may collectively perform the contraction operation regarding the expression, which is common to the collection of the plurality of expressions computed through a plurality of loop processes and is capable of being handled as a constant, and decrease the amount of operation during software execution.

The compile method described in the present embodiment may be implemented by causing a computer such as a personal computer or a workstation to execute a program prepared in advance. The present compile program is recorded in a computer-readable recording medium such as a hard disk, a flexible disk, a CD-ROM, an MO, a DVD, or the like and is executed by being read from the recording medium by the computer. Furthermore, the present compile program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a memory; and
one or more processors coupled to the memory and configured to:
specify a loop portion in which computation regarding a first expression, which performs a contraction operation with respect to a first variable, is repeated, in a first program code of software,
generate a first code in which computation regarding a second expression, which performs a contraction operation on a sub-expression of the first expression with respect to a second variable, is repeated and a second code in which computation regarding a third expression, where the sub-expression of the first expression is replaced with the second variable, is repeated, and
output a second program code in which the loop portion of the first program code is transformed into the first code and the second code.

2. The information processing apparatus according to claim 1,
wherein the processor is configured to:
specify another sub-expression which at least has the same variable and relationship between variables as a variable and relationship between variables of the sub-expression, of a fourth expression which performs a contraction operation with respect to a third variable which is present in the loop portion and
generate the first code and generates the second code in which the computation regarding the third expression where the sub-expression of the first expression is replaced with the second variable is repeated and in which computation regarding a fifth expression where the other sub-expression of the fourth expression is replaced with the second variable is repeated.

3. The information processing apparatus according to claim 1,
wherein the processor is configured to:
specify, regarding each sub-expression of the first expression, a type and the number of repetition times of the computation regarding the second expression, which performs the contraction operation on the sub-expression and a type and the number of repetition times of the computation regarding the third expression where the sub-expression of the first expression is replaced,
calculate, based on the specified type and number of repetition times, regarding each sub-expression of the first expression, a difference between an amount of operation for the loop portion and a total of an amount of operation for the repetition of the computation regarding the second expression which performs the contraction operation on the sub-expression and an amount of operation for the repetition of the computation regarding the third expression where the sub-expression is replaced,
select any of the sub-expressions of the first expression based on the calculated difference, and
generate the first code and the second code regarding any of the selected sub-expressions.

4. The information processing apparatus according to claim 3,
wherein the sub-expression is a portion of a unit sub-expression which performs the contraction operation on the first variable and
wherein the processor is configured to:
classify variables used in a condition to repeat the computation regarding the first expression into a first type variable which coincides with at least any of a variable used for an index of the first variable, a variable used in a condition to repeat computation regarding an initialization expression of the first variable, and a variable used for an index which is common to the sub-expression and the remaining sub-expression of the unit sub-expression, and a second type variable which is different from the first type variable and
specify, based on the classified first type variable and second type variable, regarding each sub-expression of the first expression, a type and the number of repetition times of the computation regarding the second expression which performs the contraction operation on the sub-expression and a type and the number of repetition times of the computation regarding the third expression where the sub-expression is replaced.

5. The information processing apparatus according to claim 1,
wherein the processor is configured to:
specify, regarding each sub-expression of the first expression, variables and the number of repetition times used in a condition to repeat the computation regarding the second expression that performs the contraction operation on the sub-expression and variables and the number of repetition times used in a condition to repeat the computation regarding the third expression where the sub-expression is replaced and
generate, based on the specified variables and the number of repetition times, the first code using a loop statement and the second code using a loop statement.

6. The information processing apparatus according to claim 5,
wherein the sub-expression is a portion of a unit sub-expression which performs the contraction operation on the first variable and
wherein the processor is configured to:
classify variables used in a condition to repeat the computation regarding the first expression into a first type variable which coincides with at least any of a variable used for an index of the first variable, a variable used in a condition to repeat computation regarding an initialization expression of the first variable, and a variable used for an index which is common to the sub-expression and the remaining sub-expression of the unit sub-expression, and a second type variable which is different from the first type variable and
specify, based on the classified first type variable and second type variable, regarding each sub-expression of the first expression, variables and the number of repetition times used in a condition to repeat the computation regarding the second expression which performs the contraction operation and variables and the number of repetition times used in a condition to repeat the computation regarding the third expression where the sub-expression is replaced.

7. The information processing apparatus according to claim 1, wherein
the first expression is an expression which performs the contraction operation with respect to the first variable by using a first operator and
the second expression is an expression which performs the contraction operation on the sub-expression with respect to the second variable by using the first operator.

8. A compile method comprising causing a computer to execute:
specifying a loop portion in which computation regarding a first expression, which performs a contraction operation with respect to a first variable, is repeated, in a first program code of software;
generating a first code in which computation regarding a second expression, which performs a contraction operation on a sub-expression of the first expression with respect to a second variable, is repeated and a second code in which computation regarding a third expression, where the sub-expression of the first expression is replaced with the second variable, is repeated; and
outputting a second program code in which the loop portion of the first program code is transformed into the first code and the second code.

9. A non-transitory, computer-readable recording medium having stored therein a compile program for causing a computer to execute a process, the process comprising:
specifying a loop portion in which computation regarding a first expression, which performs a contraction operation with respect to a first variable, is repeated, in a first program code of software;
generating a first code in which computation regarding a second expression, which performs a contraction operation on a sub-expression of the first expression with respect to a second variable, is repeated and a second code in which computation regarding a third expression, where the sub-expression of the first expression is replaced with the second variable, is repeated; and
outputting a second program code in which the loop portion of the first program code is transformed into the first code and the second code.
